(19) United States
(12) Patent Application Publication
(10) Pub. No.: US 2025/0337924 A1
(43) Pub. Date: Oct. 30, 2025

(54) ENCODING METHOD, DECODING METHOD, BITSTREAM, ENCODER, DECODER AND STORAGE MEDIUM

(71) Applicant: GUANGDONG OPPO MOBILE TELECOMMUNICATIONS CORP., LTD., Dongguan (CN)

(72) Inventor: Zexing SUN, Dongguan (CN)

(21) Appl. No.: 19/259,875

(22) Filed: Jul. 3, 2025

Related U.S. Application Data
(63) Continuation of application No. PCT/CN2023/070931, filed on Jan. 6, 2023.

(51) Int. Cl. H04N 19/167; H04N 19/105; H04N 19/169; H04N 19/172; H04N 19/96

(52) U.S. Cl. CPC H04N 19/167; H04N 19/105; H04N 19/172; H04N 19/1883; H04N 19/96

(57) ABSTRACT

Disclosed in the embodiments of the present application are an encoding method, a decoding method, a bitstream, an encoder, a decoder and a storage medium. The decoding method comprises: determining, based on a prediction node that is in a prediction frame and corresponds to a current node, planar structure information of a preset node of the current node, wherein the preset node comprises the prediction node; determining, based on the planar structure information of the preset node, context indication information of the current node; determining, based on the context indication information, target context information; and decoding a bitstream based on the target context information, to determine planar position information of the current node.

### CROSS-REFERENCE TO RELATED APPLICATIONS

This application is a continuation of International Application No. PCT/CN2023/070931, filed on Jan. 6, 2023, the disclosure of which is hereby incorporated by reference in its entirety.

### TECHNICAL FIELD

Embodiments of this application relate to the field of point cloud encoding and decoding technologies, and in particular, to an encoding method, a decoding method, a bitstream, an encoder, a decoder, and a storage medium.

### BACKGROUND

In an encoding and decoding framework of geometry-based point cloud compression (Geometry-based Point Cloud Compression, G-PCC), geometric information of a point cloud and attribute information corresponding to each point are separately encoded. For the geometric information, octree (Octree) geometry encoding and decoding or predictive geometry encoding and decoding may be used.

In a related technology, when a current node meets a plane coding condition, geometry coding efficiency of the current node is reduced due to insufficient consideration, for example, predictive encoding is performed on planar position information of the current node by using only some prior reference information.

### SUMMARY

Embodiments of this application provide an encoding method, a decoding method, a bitstream, an encoder, a decoder, and a storage medium, which may improve geometry coding efficiency of a point cloud, and further improve encoding and decoding performance of the point cloud.

The technical solutions in embodiments of this application may be implemented as follows.

According to a first aspect, an embodiment of this application provides a decoding method, applied to a decoder, where the method includes:
determining, based on a prediction node that is in a prediction frame and corresponds to a current node, planar structure information of a preset node of the current node, where the preset node includes the prediction node and at least one target node in the prediction frame;
determining, based on the planar structure information of the preset node, context indication information of the current node;
determining, based on the context indication information, target context information; and
decoding a bitstream based on the target context information, to determine planar position information of the current node.

According to a second aspect, an embodiment of this application provides an encoding method, applied to an encoder, where the method includes:
determining, based on a prediction node that is in a prediction frame and corresponds to a current node, planar structure information of a preset node of the current node, where the preset node includes the prediction node and at least one target node in the prediction frame;
determining, based on the planar structure information of the preset node, context indication information of the current node;
determining, based on the context indication information, target context information; and
determining planar position information of the current node, encoding, based on the target context information, the planar position information of the current node, and writing an encoded bit into a bitstream.

According to a third aspect, an embodiment of this application provides a bitstream, where the bitstream is generated by performing bit encoding according to to-be-encoded information, and the to-be-encoded information includes at least planar position information of a current node.

According to a fourth aspect, an embodiment of this application provides an encoder, where the encoder includes a first determining unit and an encoding unit, where
the first determining unit is configured to: determine, based on a prediction node that is in a prediction frame and corresponds to a current node, planar structure information of a preset node of the current node, where the preset node includes the prediction node and at least one target node in the prediction frame; determine, based on the planar structure information of the preset node, context indication information of the current node; determine, based on the context indication information, target context information; and determine planar position information of the current node; and
the encoding unit is configured to encode the planar position information of the current node based on the target context information, and write an encoded bit into a bitstream.

According to a fifth aspect, an embodiment of this application provides an encoder, where the encoder includes a first memory and a first processor, where
the first memory is configured to store a computer program that is runnable on the first processor; and
the first processor is configured to execute the method according to the second aspect when running the computer program.

According to a sixth aspect, an embodiment of this application provides a decoder, where the decoder includes a second determining unit and a decoding unit, where
the second determining unit is configured to: determine, based on a prediction node that is in a prediction frame and corresponds to a current node, planar structure information of a preset node of the current node, where the preset node includes the prediction node and at least one target node in the prediction frame; determine, based on the planar structure information of the preset node, context indication information of the current node; and determine, based on the context indication information, target context information; and
the decoding unit is configured to decode a bitstream based on the target context information, to determine planar position information of the current node.

According to a seventh aspect, an embodiment of this application provides a decoder, where the decoder includes a second memory and a second processor, where
the second memory is configured to store a computer program that is runnable on the second processor; and
the second processor is configured to execute the method according to the first aspect when running the computer program.

According to an eighth aspect, an embodiment of this application provides a computer-readable storage medium, where the computer-readable storage medium stores a computer program, and when the computer program is executed, the method according to the first aspect or the method according to the second aspect is implemented.

Embodiments of this application provide an encoding method, a decoding method, a bitstream, an encoder, a decoder, and a storage medium. No matter at an encoding end or a decoding end, planar structure information of a preset node of a current node is determined based on a prediction node that is in a prediction frame and corresponds to the current node, where the preset node includes the prediction node and at least one target node in the prediction frame; context indication information of the current node is determined based on the planar structure information of the preset node; and target context information is determined based on the context indication information. In this way, at the encoding end, after planar position information of the current node is determined, the planar position information of the current node is encoded based on the target context information, and an encoded bit is written into a bitstream. At the decoding end, the bitstream may be decoded based on the target context information, to determine the planar position information of the current node. That is, in a process of encoding and decoding the planar position information of the current node by using the target context information, the target context information is determined by considering the planar structure information of the prediction node in the prediction frame.

### BRIEF DESCRIPTION OF DRAWINGS

FIG. 1A is a schematic diagram of a three-dimensional point cloud image.

FIG. 1B is a schematic diagram of a locally enlarged view of the three-dimensional point cloud image.

FIG. 2A is a schematic diagram of a point cloud image viewed from different angles.

FIG. 2B is a schematic diagram of a data storage format corresponding to FIG. 2A.

FIG. 3 is a schematic diagram of a network architecture for point cloud encoding and decoding.

FIG. 4A is a schematic block diagram of composition of a G-PCC encoder.

FIG. 4B is a schematic block diagram of composition of a G-PCC decoder.

FIG. 5A is a schematic diagram of low planar positions.

FIG. 5B is a schematic diagram of high planar positions.

FIG. 6 is a schematic diagram of a node coding sequence.

FIG. 7A is a schematic diagram of a type planar mode information.

FIG. 7B is a schematic diagram of another type planar mode information.

FIG. 8 is a schematic diagram of IDCM coding.

FIG. 9A is a schematic diagram of vertices in a block.

FIG. 9B is a schematic diagram of triangular patch fitting of a block.

FIG. 9C is a schematic diagram of upsampling of a block.

FIG. 10 is a schematic flowchart of a decoding method according to an embodiment of this application.

FIG. 11 is a schematic diagram of inter-frame plane coding according to an embodiment of this application.

FIG. 12 is a schematic diagram of a location relationship between a prediction node and neighboring nodes according to an embodiment of this application.

FIG. 13 is a schematic diagram of another location relationship between a prediction node and neighboring nodes according to an embodiment of this application.

FIG. 14 is a schematic diagram of a neighboring node at a same partitioning depth and a same coordinate according to an embodiment of this application.

FIG. 15 is a schematic flowchart of an encoding method according to an embodiment of this application.

FIG. 16 is a schematic diagram of sibling nodes of a current node according to an embodiment of this application.

FIG. 17 is a schematic diagram of intersection between lasers of a LiDAR device and a node according to an embodiment of this application.

FIG. 18 is a schematic diagram showing that a current node is located on a low plane of a parent node according to an embodiment of this application.

FIG. 19 is a schematic diagram showing that a current node is located on a high plane of a parent node according to an embodiment of this application.

FIG. 20 is a schematic diagram of predictive encoding of planar position information of a LiDAR point cloud according to an embodiment of this application.

FIG. 21 is a schematic structural diagram of an encoder according to an embodiment of this application.

FIG. 22 is a schematic structural diagram of specific hardware of an encoder according to an embodiment of this application.

FIG. 23 is a schematic structural diagram of a decoder according to an embodiment of this application.

FIG. 24 is a schematic structural diagram of specific hardware of a decoder according to an embodiment of this application.

FIG. 25 is a schematic structural diagram of an encoding and decoding system according to an embodiment of this application.

### DESCRIPTION OF EMBODIMENTS

To understand features and technical content of embodiments of this application in more detail, the following describes implementation of embodiments of this application in detail with reference to the accompanying drawings. The accompanying drawings are merely used for description, and are not intended to limit embodiments of this application.

Unless otherwise defined, all technical and scientific terms used in this specification have the same meaning as commonly understood by those skilled in the technical field of this application. The terms used herein are merely for the purpose of describing embodiments of this application, but are not intended to limit this application.

In the following descriptions, the term “some embodiments” describes a subset of all possible embodiments, but it may be understood that “some embodiments” may be the same subset or different subsets of all possible embodiments and may be combined without a conflict.

It should also be noted that the term “first/second/third” used in embodiments of this application is merely used to distinguish between similar objects and does not represent a specific order of objects. It may be understood that “first/second/third” may be interchanged if allowed, so that embodiments of this application described herein may be implemented in a sequence other than the sequence illustrated or described herein.

A point cloud (Point Cloud) is a three-dimensional representation of a surface of an object. By using a collection device such as an optoelectronic radar, a LiDAR device, a laser scanner, or a multi-angle camera, a point cloud (data) of a surface of an object may be collected.

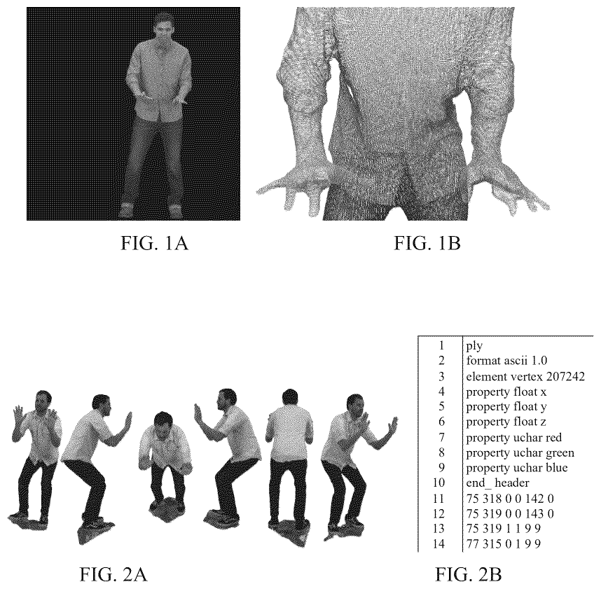

The point cloud is a set of discrete points in space that are irregularly distributed and represent a spatial structure and surface attributes of a three-dimensional object or scene. FIG. 1A is a three-dimensional point cloud image, and FIG. 1B is a locally enlarged view of the three-dimensional point cloud image. It may be seen that a surface of the point cloud includes densely distributed points.

Pixels of a two-dimensional image each express some information and follow a distribution rule. Therefore, position information of the two-dimensional image does not need to be additionally recorded. However, points in a point cloud in a three-dimensional space are randomly and irregularly distributed. Therefore, a position of each point in the space needs to be recorded, to fully express the point cloud. Similar to that in the two-dimensional image, in a collection process, each position has corresponding attribute information, which is usually an RGB color value. The color value reflects a color of an object. For the point cloud, in addition to color information, attribute information corresponding to each point generally includes a reflectance (reflectance) value. The reflectance value reflects a surface material of the object. Therefore, a point in the point cloud may have position information of the point and attribute information of the point. For example, the position information of the point may be three-dimensional coordinate information (x,y,z) of the point. The position information of the point may also be referred to as geometric information of the point. For example, the attribute information of the point may include color information (three-dimensional color information) and/or reflectance (one-dimensional reflectance information r). For example, the color information may be information in any type of color space. For example, the color information may be RGB information, where R represents red (Red, R), G represents green (Green, G), and B represents blue (Blue, B). For another example, the color information may be luma and chroma (YCbCr, YUV) information, where Y represents luma (Luma), Cb(U) represents a blue color difference, and Cr(V) represents a red color difference.

A point in a point cloud obtained according to a laser measurement principle may have three-dimensional coordinate information of the point and a reflectance value of the point. For another example, a point in a point cloud obtained according to a photographing measurement principle may have three-dimensional coordinate information of the point and three-dimensional color information of the point. For another example, a point in a point cloud obtained according to a laser measurement principle and a photographing measurement principle may have three-dimensional coordinate information of the point, a reflectance value of the point, and three-dimensional color information of the point.

FIG. 2A and FIG. 2B show a point cloud image and a data storage format corresponding to the point cloud image. FIG. 2A provides six angles of viewing a point cloud image, and FIG. 2B includes a file header information part and a data part. Header information includes a data format, a data representation type, a total quantity of points in a point cloud, and content represented by the point cloud. For example, the point cloud is in a “.ply” format and is represented by an ASCII code. The total quantity of the points in the point cloud is 207242, and each point has three-dimensional coordinate information (x, y, z) and three-dimensional color information (r, g, b).

According to acquisition methods, point clouds may be classified into the following three types:
static point cloud, for which an object is still, and a device for acquiring the point cloud is also still;
dynamic point cloud, for which an object is moving, but a device for acquiring the point cloud is still; and
dynamically acquired point cloud, for which a device for acquiring the point cloud is moving.

For example, according to usage, point clouds are classified into the following two types:
type 1: machine perception point cloud, which may be used in scenarios such as an autonomous navigation system, a real-time inspection system, a geographic information system, a visual sorting robot, or a disaster relief robot; and
type 2: human eye perception point cloud, which may be used in point cloud application scenarios such as a digital cultural heritage, free viewpoint broadcasting, three-dimensional immersive communication, or three-dimensional immersive interaction.

A point cloud may flexibly and conveniently express a spatial structure and a surface attribute of a three-dimensional object or scene. Since the point cloud is obtained by directly performing sampling on a real object, an extremely strong sense of reality can be provided on a premise of ensuring precision. Therefore, the point cloud is widely applied in virtual reality gaming, computer-aided design, a geographic information system, an automatic navigation system, a digital cultural legacy, free viewpoint broadcasting, three-dimensional immersive remote presentation, three-dimensional reconstruction of a biological organ, and the like.

Point clouds are mainly collected in the following manners: computer generation, 3D laser scanning, 3D photographing measurement, and the like. A computer may be used to generate a point cloud of a virtual three-dimensional object or scene. 3D laser scanning may be used to obtain a point cloud of a three-dimensional object or scene in a static real world, and can acquire millions of point clouds per second. 3D photographing measurement may be used to obtain a point cloud of a three-dimensional object or scene in a dynamic real world, and can acquire tens of millions of point clouds per second. These technologies reduce costs and a time period of acquiring point cloud data, and improve data precision. The development in the manners of acquiring point cloud data make it possible to acquire a large amount of point cloud data. With increasing application requirements, processing of massive 3D point cloud data encounters bottlenecks of limited storage space and transmission bandwidth.

Exemplarily, a point cloud video with a frame rate of 30 frames per second (fps) is used as an example. A quantity of points in each frame of point cloud is 700,000, and each point has coordinate information xyz (float) and color information RGB (uchar). In this case, a data volume of a 10 s point cloud video is approximately 0.7 million×(4 byte×3+1 byte×3)×30 fps×10 s=3.15 GB, where 1 byte is 10 bits. A data volume of a 10 s 1280×720 two-dimensional video with a YUV sampling format of 4:2:0 and a frame rate of 24 fps is approximately 1280×720×12 bit×24 fps×10 s≈0.33 GB, and a data volume of a 10 s two-view three-dimensional video is approximately 0.33×2=0.66 GB. It may be seen that a data volume of a point cloud video is far more than a data volume of a two-dimensional or three-dimensional video with a same length. Therefore, to better implement data management, save server storage space, and reduce transmission traffic and transmission time between servers and clients, point cloud compression becomes a key for promoting development of point cloud industries.

That is, since a point cloud is a set of massive points, storing the point cloud not only consumes a large amount of memory but also is non-conducive to transmission. In addition, there is no such bandwidth that can support direct transmission of a point cloud at a network layer without compression. Therefore, the point cloud needs to be compressed.

Currently, a point cloud encoding framework that can be used to compress a point cloud may be a geometry-based point cloud compression (Geometry-based Point Cloud Compression, G-PCC) encoding and decoding framework or a video-based point cloud compression (Video-based Point Cloud Compression, V-PCC) encoding and decoding framework provided by a moving picture experts group (Moving Picture Experts Group, MPEG), or may be an AVS-PCC encoding and decoding framework provided by an audio video standard (Audio Video Standard, AVS). The G-PCC encoding and decoding framework may be used to compress a static point cloud of the type 1 and a dynamically acquired point cloud of the type 3, and the V-PCC encoding and decoding framework may be used to compress a dynamic point cloud of the type 2. The G-PCC encoding and decoding framework is also referred to as a point cloud codec TMC13, and the V-PCC encoding and decoding framework is also referred to as a point cloud codec TMC2.

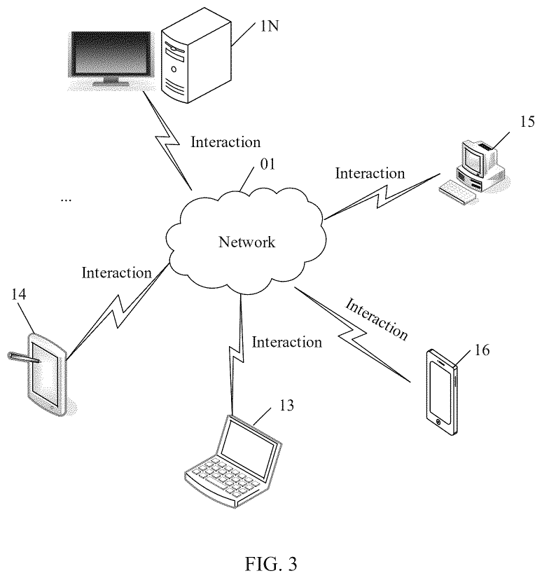

Embodiments of this application provide a network architecture of a point cloud encoding and decoding system including a decoding method and an encoding method. FIG. 3 is a schematic diagram of a network architecture for point cloud encoding and decoding according to an embodiment of this application. As shown in FIG. 3, the network architecture includes one or more electronic devices 13 to IN and a communications network 01, where the electronic devices 13 to IN may perform video interaction with each other by using the communications network 01. In an implementation process, the electronic device may be various types of devices that have a point cloud encoding and decoding function. For example, the electronic device may include a mobile phone, a tablet computer, a personal computer, a personal digital assistant, a navigator, a digital telephone, a video telephone, a television, a sensing device, a server, or the like. This is not limited in embodiments of this application.

A decoder or an encoder in embodiments of this application may be the foregoing electronic device. That is, the electronic device in embodiments of this application has a point cloud encoding and decoding function, and generally includes a point cloud encoder (that is, an encoder) or a point cloud decoder (that is, a decoder).

The following describes a point cloud compression technology by using a G-PCC encoding and decoding framework as an example.

It may be understood that, in a G-PCC encoding and decoding framework for a point cloud, to-be-encoded point cloud data is first partitioned into a plurality of slices through slicing (slice). In each slice, geometric information and attribute information of the point cloud are separately encoded.

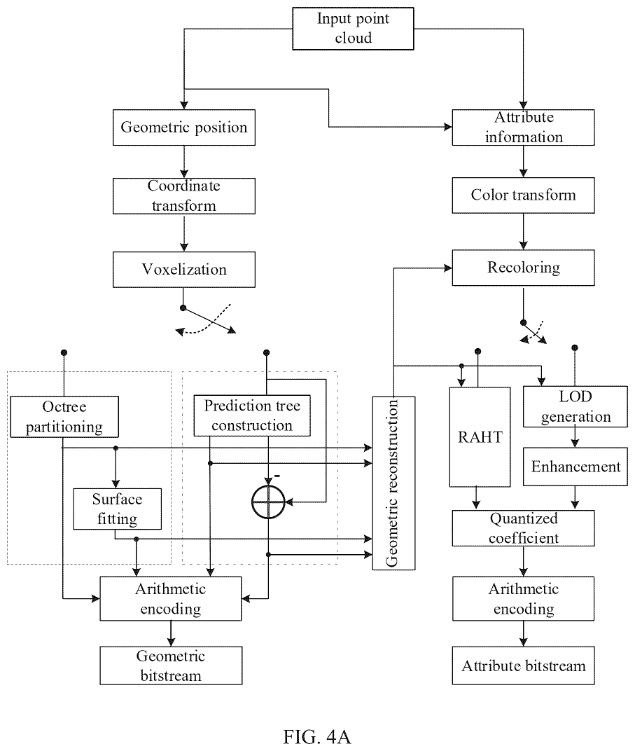

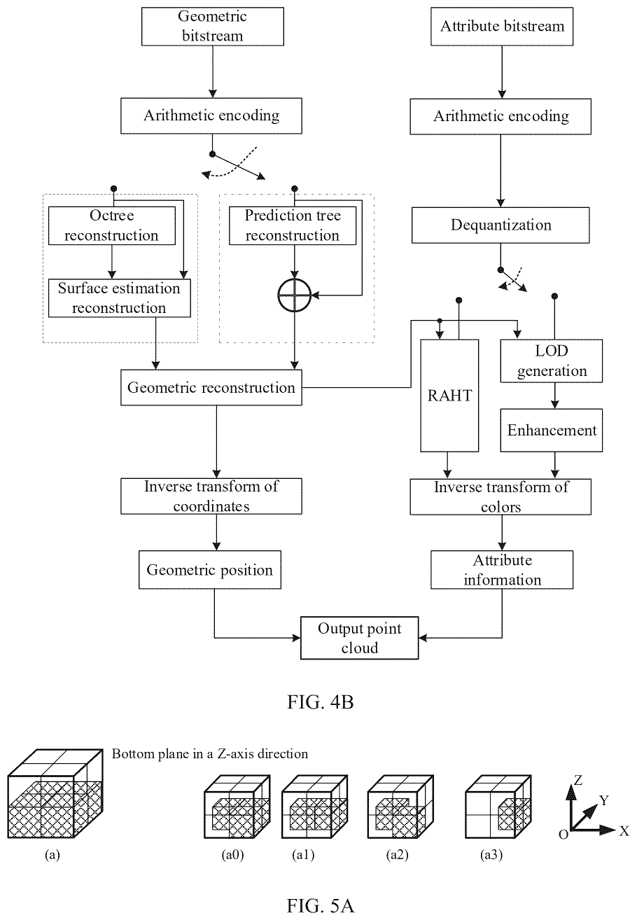

FIG. 4A is a schematic diagram of a framework of a G-PCC encoder. As shown in FIG. 4A, in a geometry encoding process, coordinate transform is performed on geometric information, so that an entire point cloud is included in a bounding box (Bounding Box), and then quantization is performed. The quantization in this step mainly plays a role of scaling. Due to rounding in the quantization, a part of the point cloud has same geometric information. Then, whether to remove duplicate points is determined based on a parameter. The process of quantization and removal of duplicate points is also referred to as voxelization. Next, octree partitioning or prediction tree construction is performed on the bounding box. In this process, arithmetic encoding is performed on points in leaf nodes generated after partitioning, to generate a binary geometric bitstream; or arithmetic encoding (surface fitting based on vertices) is performed on vertices (Vertex) generated by partitioning, to generate a binary geometric bitstream. In an attribute encoding process, geometry encoding is already completed. After the geometric information is reconstructed, color transform needs to be performed first, to transform color information (that is, attribute information) from an RGB color space to a YUV color space. Then, the point cloud is colored again by using the reconstructed geometric information, so that attribute information that is not encoded corresponds to the reconstructed geometric information. Attribute encoding is mainly performed on color information. In a process of encoding the color information, there are mainly two transform methods. One method is distance-based enhanced transform that depends on level of detail (Level of Detail, LOD) partitioning, and the other method is to directly perform region adaptive hierarchal transform (Region Adaptive Hierarchal Transform, RAHT). In both methods, the color information is transformed from a spatial domain to a frequency domain, to obtain a high frequency coefficient and a low frequency coefficient. Finally, the coefficients are quantized to obtain quantized coefficients, and then arithmetic encoding is performed on the quantized coefficients to generate a binary attribute bitstream.

FIG. 4B is a schematic diagram of a framework of a G-PCC decoder. As shown in FIG. 4B, for an acquired binary bitstream, a geometric bitstream and an attribute bitstream in the binary bitstream are first separately decoded. During decoding of the geometric bitstream, geometric information of the point cloud is obtained through arithmetic decoding-octree reconstruction or prediction tree reconstruction-geometric reconstruction-inverse transform of coordinates. During decoding of the attribute bitstream, attribute information of the point cloud is obtained through arithmetic decoding-dequantization-LOD partitioning or RAHT-inverse transform of colors. Based on the geometric information and the attribute information, to-be-encoded point cloud data (that is, the output point cloud) is restored.

It should be noted that, as shown in FIG. 4A or FIG. 4B, currently G-PCC geometry encoding and decoding may include octree geometry encoding and decoding (shown in a dashed box) and predictive geometry encoding and decoding (shown in a dash-dotted box).

Octree geometry encoding (Octree geometry encoding, OctGeomEnc) includes the following steps. First, coordinate transform is performed on geometric information, so that an entire point cloud is included in a bounding box. Then, quantization is performed. The quantization in this step mainly plays a role of scaling. Due to rounding in the quantization, some points have same geometric information. Then, whether to remove duplicate points is determined based on a parameter. The process of quantization and removal of duplicate points is also referred to as voxelization. Next, partitioning of a tree (for example, an octree, a quadtree, or a binary tree) is continuously performed on the bounding box in a breadth-first traversal sequence, and a occupancy code of each node is encoded. In a related technology, a company proposes an implicit geometric partitioning manner. First, a bounding box (2^{d}^{ₓ}, 2^{d}^{_{y}}, 2^{d}^{_{z}}) of a point cloud is calculated. It is assumed that dₓ>d_{y}>d_{z}, and the bounding box is correspondingly a cube. During geometric partitioning, first, binary tree partitioning is continuously performed based on an x-axis, to continuously obtain two child nodes. Only when a condition dₓ=d_{y}>d_{z} is met, quadtree partitioning is continuously performed based on the x-axis and a y-axis, to continuously obtain four child nodes. When a condition dₓ=d_{y}=d_{z} is finally met, octree partitioning is continuously performed until leaf nodes obtained by the partitioning are 1×1×1 unit cubes. Then, points in the leaf nodes are encoded, to generate a binary bitstream. In a process of partitioning based on a binary tree, a quadtree, or an octree, two parameters K and M are introduced. The parameter K indicates a maximum quantity of times of binary tree or quadtree partitioning before octree partitioning, and the parameter M is used to indicate that a side length of a minimum block corresponding to binary tree or quadtree partitioning is 2^{M}. In addition, K and M must meet the following condition: assuming that dₘₐₓ=max(dₓ, d_{y}, d_{z}) and dₘᵢₙ=min(dₓ, d_{y}, d_{z}), the parameter K meets K≥dₘₐₓ−dₘᵢₙ and the parameter M meets M≥ dₘᵢₙ. A reason why the parameters K and M meet the foregoing condition is that, in the current implicit geometric partitioning of G-PCC, partitioning manners in descending order of priorities are binary tree partitioning, quadtree partitioning, and octree partitioning. Only when a size of a node block does not meet a condition of binary tree or quadtree partitioning, octree partitioning is continuously performed on the node until leaf nodes of a minimum unit 1×1×1 are obtained. In an octree geometry encoding mode, geometric information of a point cloud may be effectively encoded by using correlation between adjacent points in space. However, for some relatively flat nodes or nodes that have a planar feature, coding efficiency of the geometric information of the point cloud may be further improved by using a plane coding mode.

Exemplarily, FIG. 5A and FIG. 5B are schematic diagrams of planar positions. FIG. 5A is a schematic diagram of low planar positions in a Z-axis direction, and FIG. 5B is a schematic diagram of high planar positions in a Z-axis direction. As shown in FIG. 5A, (a), (a0), (a1), (a2), and (a3) herein all belong to low planar positions in a Z-axis direction. By using (a) as an example, it can be seen that four occupied child nodes in a current node are all located in low planar positions in a Z-axis direction of the current node. In this case, it may be considered that the current node belongs to a Z-plane which is a low plane in the Z-axis direction. Similarly, as shown in FIG. 5B, (b), (b0), (b1), (b2), and (b3) herein all belong to high planar positions in a Z-axis direction. By using (b) as an example, it can be seen that four occupied child nodes in a current node are located in high planar positions in a Z-axis direction of the current node. In this case, it may be considered that the current node belongs to a Z-plane which is a high plane in the Z-axis direction.

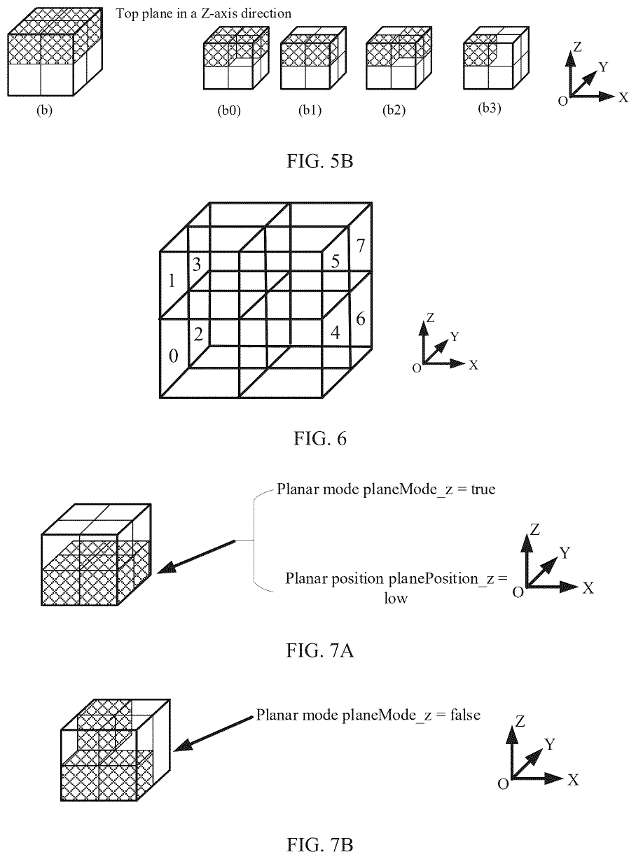

Further, octree coding efficiency is compared against plane coding efficiency. FIG. 6 is a schematic diagram of a node coding sequence, that is, node coding is performed in a sequence of 0, 1, 2, 3, 4, 5, 6, and 7 shown in FIG. 6. Herein, if an octree coding manner is used for (a) in FIG. 5A, occupancy information of the current node is represented as 11001100. However, if a plane coding manner is used, first, an identifier needs to be encoded, to indicate that the current node is a plane in the Z-axis direction. Then, if the current node is a plane in the Z-axis direction, a planar position of the current node also needs to be represented. Next, only occupancy information (that is, occupancy information of four child nodes 0, 2, 4, and 6) of low-plane nodes in the Z-axis direction needs to be encoded. Therefore, if the current node is encoded based on the plane coding manner, only six bits (bit) need to be encoded. Compared with octree coding in a related technology, plane coding reduces representation by two bits. Based on this analysis, plane coding has more evident coding efficiency than octree coding. Therefore, for an occupied node, if a plane coding manner is used for coding in a dimension, first, planar mode (planarMode) information and planar position (PlanePos) of the current node in the dimension need to be represented. Then, occupancy information of the current node is encoded based on planar information of the current node. Exemplarily, FIG. 7A is a schematic diagram of a type of planar mode information. As shown in FIG. 7A, a low plane exists in the Z-axis direction. Correspondingly, a value of planar mode information is true (true) or 1, that is, planarMode_z=true. A value of planar position information is low (low), that is, PlanePosition_z=low. FIG. 7B is a schematic diagram of another type of planar mode information. As shown in FIG. 7B, it is not a plane in the Z-axis direction. Correspondingly, a value of planar mode information is false (false) or 0, that is, planarMode_z=false.

It should be noted that for PlaneMode_ᵢ, 0 represents that a current node is not a plane in an i-axis direction, and 1 represents that the current node is a plane in the i-axis direction. If the current node is a plane in the i-axis direction, for PlanePosition_ᵢ, 0 indicates that the current node is a low plane in the i-axis direction, and 1 indicates that the current node is a high plane in the i-axis direction. Herein, i represents a coordinate dimension, which may be an X-axis direction, a Y-axis direction, or a Z-axis direction. Therefore, i=0, 1, or 2.

However, the octree geometry encoding mode has an efficient compression rate only for points that are correlated in space. For a point that is in an isolated position in a geometric space, complexity may be greatly reduced by using a direct coding model (Direct Coding Model, DCM). For all nodes in an octree, usage of the DCM is not represented by flag information, but is inferred by using information about a parent node and a neighbor of a current node. Whether the current node is eligible for DCM coding is determined in the following three manners.

(1) The current node has no sibling nodes, that is, the parent node of the current node has only one child node, and a parent node of the parent node of the current node has only two occupied child nodes, that is, the current node has a maximum of one neighboring node.

(2) The parent node of the current node has only one occupied child node, that is, the current node, and six neighboring nodes that are coplanar with the current node are all empty nodes.

(3) A quantity of sibling nodes of the current node is greater than 1.

Exemplarily, FIG. 8 is a schematic diagram of coding in an infer direct coding model (Infer Direct Coding Model, IDCM). If a current node is not eligible for DCM coding, octree partitioning is performed on the current node. If the current node is eligible for DCM coding, a quantity of points included in the node is further determined. If the quantity of points is less than a threshold (for example, 2), DCM coding is performed on the node. Otherwise, octree partitioning is continued. When the DCM coding mode is applied, first, it needs to be encoded whether the current node is a real isolated point, that is, IDCM_flag. When IDCM_flag is true, DCM coding is used for the current node. Otherwise, octree coding is still used. When the current node meets a DCM coding condition, a DCM coding mode needs to be encoded for the current node. Currently, there are two DCM modes: (a) There is only one point (or a plurality of points that are duplicate points); (b) There are two points. Finally, geometric information of each point needs to be encoded. Assuming that a side length of the node is 2^{d}, d bits are required for encoding each component of geometric coordinates of the node, and the bit information is directly encoded into a bitstream. It should be noted herein that, when a LiDAR point cloud is encoded, predictive encoding is performed on coordinate information in three dimensions by using a LiDAR collection parameter, thereby further improving coding efficiency of geometric information.

It should also be noted that, when a node is divided into leaf nodes, in a case of lossless geometry encoding, a quantity of duplicate points in the leaf nodes needs to be encoded. Finally, occupancy information of all nodes is encoded to generate a binary bitstream. In addition, currently a plane coding mode is introduced into G-PCC. In a process of geometric partitioning, it is determined whether child nodes of a current node are on a same plane. If the child nodes of the current node meet a condition of being on the same plane, the plane is used to represent the child nodes of the current node.

For octree geometry decoding, before a decoding end decodes occupancy information of each node in a breadth-first traversal sequence, the decoding end first determines, by using reconstructed geometric information, whether to perform planar decoding or IDCM decoding on a current node. If the current node meets a condition of planar decoding, the decoding end first decodes planar mode information and planar position information of the current node, and then decodes, based on planar information, occupancy information of the current node. If the current node meets a condition of IDCM decoding, the decoding end first decodes whether the current node is a real IDCM node. If the current node is a real IDCM node, the decoding end parses a DCM decoding mode of the current node, and then may obtain a quantity of points in the current DCM node. Finally, the decoding end decodes geometric information of each point. For a node that meets neither plane decoding nor DCM decoding, occupancy information of the current node is decoded. In this manner, a occupancy code of each node is obtained through continuous parsing, and nodes are successively divided until 1×1×1 unit cubes are obtained. A quantity of points included in each leaf node is obtained through parsing, and finally, reconstructed geometric information of a point cloud is restored.

For geometric information coding based on a triangle soup (triangle soup, trisoup), geometric partitioning needs to be performed first in a geometric information coding framework based on a trisoup. However, different from that in geometric information coding based on a binary tree, a quadtree, or an octree, in this method, a point cloud does not need to be divided into unit cubes with side lengths of 1×1×1, but is divided until a block (block) with a side length of W is obtained. Based on a surface formed by point clouds in each block, a maximum of twelve vertices (vertex) generated by the surface and twelve edges of the block are obtained. Vertex coordinates of each block are successively encoded to generate a binary bitstream.

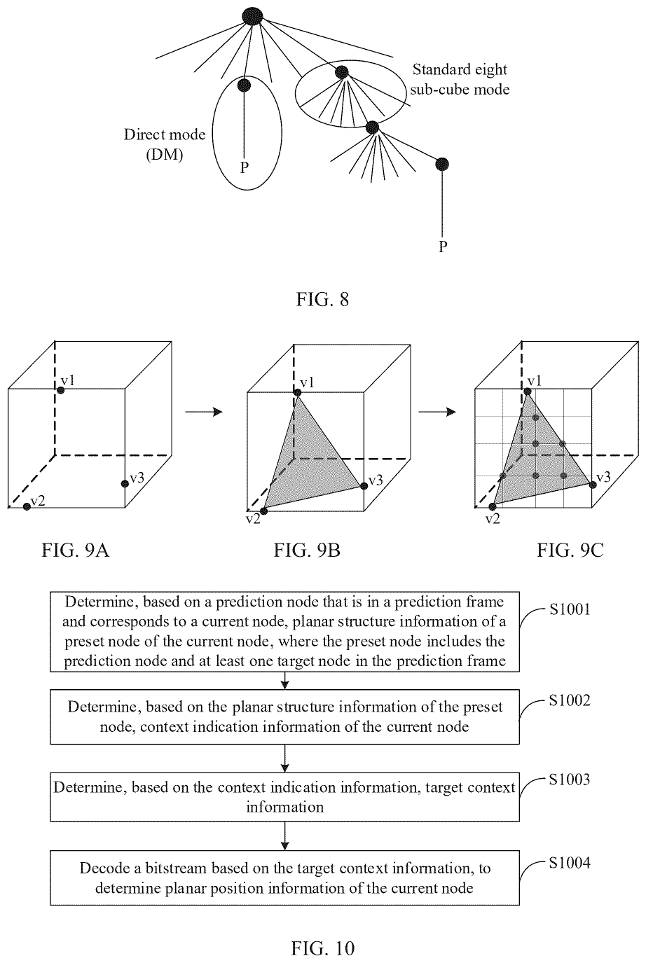

When reconstructing geometric information of a point cloud based on a trisoup, a decoding end first decodes vertex coordinates, to reconstruct a triangular patch. This process is shown in FIG. 9A, FIG. 9B, and FIG. 9C. There are three vertices (v1, v2, and v3) in the block shown in FIG. 9A. A triangle soup is formed by the three vertices in a specific order, that is, trisoup, as shown in FIG. 9B. Then, sampling is performed on the triangle soup, and obtained sampling points are used as a reconstructed point cloud in the block, as shown in FIG. 9C.

Predictive geometry coding (Predictive geometry coding, PredGeom Tree) includes: sorting points of an input point cloud in sequence first, where sorting methods currently used include disordering, Morton ordering, azimuth ordering, and radial distance ordering. At an encoding end, a prediction tree structure is established in two different modes, including KD-tree (a high-latency slow mode) and a low-latency fast mode (by using LiDAR calibration information). When the LiDAR calibration information is used, points are assigned to different lasers (Laser), and a prediction tree structure is established according to the different lasers. Next, based on the prediction tree structure, each node in the prediction tree is traversed, geometric position information of the nodes is predicted by selecting different prediction modes, to obtain prediction residuals, and the geometric prediction residuals are quantized by using a quantization parameter. Finally, with continuously iterations, the prediction residuals of position information of the prediction tree nodes, the prediction tree structure, the quantization parameter, and the like are encoded to generate a binary bitstream.

For predictive geometry decoding, a decoding end continuously parses the bitstream to reconstruct a prediction tree structure, obtains prediction residual information of a geometric position of each prediction node and a quantization parameter through the parsing, and dequantizes the prediction residual to obtain reconstructed geometric position information of each node and finally complete geometric reconstruction.

After geometry encoding is completed, geometric information needs to be reconstructed. Currently, attribute encoding is mainly performed on color information. First, the color information is converted from an RGB color space to a YUV color space. Then, the point cloud is colored again by using the reconstructed geometric information, so that attribute information that is not encoded corresponds to the reconstructed geometric information. During encoding of the color information, there are mainly two transform methods. One method is distance-based enhanced transform based on LOD partitioning, and the other method is to directly perform RAHT. In both methods, the color information is transformed from a spatial domain to a frequency domain, to obtain a high frequency coefficient and a low frequency coefficient. Finally, the coefficients are quantized and encoded to generate a binary bitstream. For details, refer to FIG. 4A and FIG. 4B.

Further, when the attribute information is predicted by using the geometric information, a Morton code is used to perform nearest neighbor search. The Morton code corresponding to each point in the point cloud may be obtained by using geometric coordinates of the point. The following describes a specific method for calculating the Morton code. For three-dimensional coordinates in which each component is represented by a binary number with d bits, the three components may be represented as:

$$x = {\sum }_{ℓ = 1}^{d} {2}^{d - ℓ} {x}_{ℓ} , \qquad ( 1 )$$

$$y = {\sum }_{ℓ = 1}^{d} {2}^{d - ℓ} {y}_{ℓ} ,$$

$$z = {\sum }_{ℓ = 1}^{d} {2}^{d - ℓ} {z}_{ℓ}$$

Herein, [symbol] , [symbol] , [symbol] ∈{0,1} are respectively a binary value corresponding to a most significant bit ( [symbol] =1) to a least significant bit ( [symbol] =d) of x, y, and z. The Morton code Mis obtained by arranging, for z, y, and z, [symbol] , [symbol] , [symbol] in a sequence from the most significant bit to the least significant bit. A calculation formula of M is as follows:

$$M = {\sum }_{ℓ = 1}^{d} {2}^{3 ( d - ℓ )} ( 4 {x}_{ℓ} + 2 {y}_{ℓ} + {z}_{ℓ} ) = {\sum }_{{ℓ}^{′} = 1}^{3 d} {2}^{3 d - {ℓ}^{′}} {m}_{{ℓ}^{′}} \qquad ( 2 )$$

Herein, [symbol] ∈{0,1} represents values from the most significant bit ( [symbol] =1) to the least significant bit ( [symbol] =3d) of M. After the Morton code M of each point in the point cloud is obtained, the points in the point cloud are arranged in ascending order of Morton codes, and a weight value w of each point is set to 1.

It may be further understood that, for a G-PCC encoding and decoding framework, common test conditions are as follows.

(1) There are four test conditions.

Condition 1: A geometric position is limited lossy and an attribute is lossy.

Condition 2: A geometric position is lossless and an attribute is lossy.

Condition 3: A geometric position is lossless and an attribute is limited lossy.

Condition 4: A geometric position is lossless and an attribute is lossless.

(2) A common test sequence includes four types: Cat1A, Cat1B, Cat3-fused, and Cat3-frame. A Cat2-frame point cloud includes only reflectance attribute information, a Cat1A or Cat1B point cloud includes only color attribute information, and a Cat3-fused point cloud includes both color attribute information and reflectance attribute information.

(3) There are two types of technical roadmaps, which are distinguished by algorithms used for geometric compression.

### Technical Roadmap 1: Octree Geometry Encoding Branch

At an encoding end, a bounding box is divided into sub-cubes, and sub-cubes (including points in a point cloud) that are not empty are further divided until leaf nodes obtained by the partitioning are 1×1×1 unit cubes. In a case of lossless geometry encoding, a quantity of points included in each leaf node needs to be encoded, to finally complete octree geometry encoding and generate a binary bitstream.

At a decoding end, parsing is continuously performed in a breadth-first traversal sequence, to obtain a occupancy code of each node, and the nodes are sequentially divided until unit cubes of 1×1×1 are obtained. In a case of lossless geometry decoding, parsing needs to be performed to obtain a quantity of points included in each leaf node, to finally obtain reconstructed geometric information of a point cloud through restoration.

### Technical Roadmap 2: Predictive Geometry Coding Branch

At an encoding end, a prediction tree structure is established in two different modes: KD-tree (a high-latency slow mode) and LiDAR calibration information (a low-latency fast mode). By using the LiDAR calibration information, the points are assigned to different lasers, and a prediction tree structure is established according to the different lasers. Next, based on the prediction tree structure, each node in the prediction tree is traversed, geometric position information of the nodes is predicted by selecting different prediction modes, to obtain prediction residuals, and the geometric prediction residuals are quantized by using a quantization parameter. Finally, with continuously iterations, the prediction residuals of position information of the prediction tree nodes, the prediction tree structure, the quantization parameter, and the like are encoded to generate a binary bitstream.

At a decoding end, bitstreams are continuously parsed to reconstruct a prediction tree structure, prediction residual information of a geometric position of each prediction node and a quantization parameter are obtained through the parsing, and the prediction residual is dequantized to obtain reconstructed geometric position information of each node and finally complete geometric reconstruction.

Briefly, when a current node meets a plane coding condition, in a related technology, planar position information of the current node is predicted, encoded, and decoded by using only some prior reference information, and time domain correlation of nodes between adjacent frames is not considered. In this case, when the planar position information of the current node is predicted, encoded, and decoded, geometry coding efficiency of the current node is reduced due to insufficient consideration.

Based on this, embodiments of this application provide an encoding method and a decoding method. At an encoding end, planar structure information of a preset node of a current node is determined based on a prediction node that is in a prediction frame and corresponds to the current node, where the preset node includes the prediction node and at least one target node in the prediction frame; context indication information of the current node is determined based on the planar structure information of the preset node; target context information is determined based on the context indication information; and planar position information of the current node is determined, the planar position information of the current node is encoded based on the target context information, and an encoded bit is written into a bitstream. At a decoding end, the planar structure information of the preset node of the current node is determined based on the prediction node that is in the prediction frame and corresponds to the current node, where the preset node includes the prediction node and the at least one target node in the prediction frame; the context indication information of the current node is determined based on the planar structure information of the preset node; target context information is determined based on the context indication information; and the bitstream is decoded based on the target context information, to determine the planar position information of the current node. In this way, in a process of encoding and decoding the planar position information of the current node by using the target context information, the target context information is determined by considering the planar structure information of the prediction node in the prediction frame. In this way, coding efficiency of geometric information of a point cloud may be effectively improved by considering correlation between planar structure information of corresponding nodes in adjacent prediction frames. In addition, time domain correlation between the adjacent prediction frames is used to remove redundancy of planar structure information between the adjacent frames, which may further improve the coding efficiency of the geometric information of the point cloud, thereby improving encoding and decoding performance of the point cloud.

The following describes embodiments of this application in detail with reference to the accompanying drawings.

In an embodiment of this application, FIG. 10 is a schematic flowchart of a decoding method according to this embodiment of this application. As shown in FIG. 10, the method may include the following steps.

S1001: Determine, based on a prediction node that is in a prediction frame and corresponds to a current node, planar structure information of a preset node of the current node, where the preset node includes the prediction node and at least one target node in the prediction frame.

It should be noted that the decoding method according to this embodiment of this application is applied to a decoder. In addition, the decoding method may refer to a point cloud geometry decoding method, which is specifically an inter-frame plane decoding method, and more specifically, a method for determining context information based on a point cloud plane coding mode. Then, planar position information of a current node is decoded according to determined target context information.

It should be further noted that, points in a point cloud may be all points in the point cloud, or may be some points in the point cloud, which are relatively concentrated in space. Herein, the current node specifically refers to a node that is in the point cloud and is currently to be decoded.

In this embodiment of this application, the prediction frame is a decoded frame, and the prediction frame is adjacent to a current frame that includes the current node. That is, the prediction frame is a decoded reference frame adjacent to the current frame, and time domain correlation of nodes between adjacent prediction frames may be used to improve plane decoding efficiency of the current node.

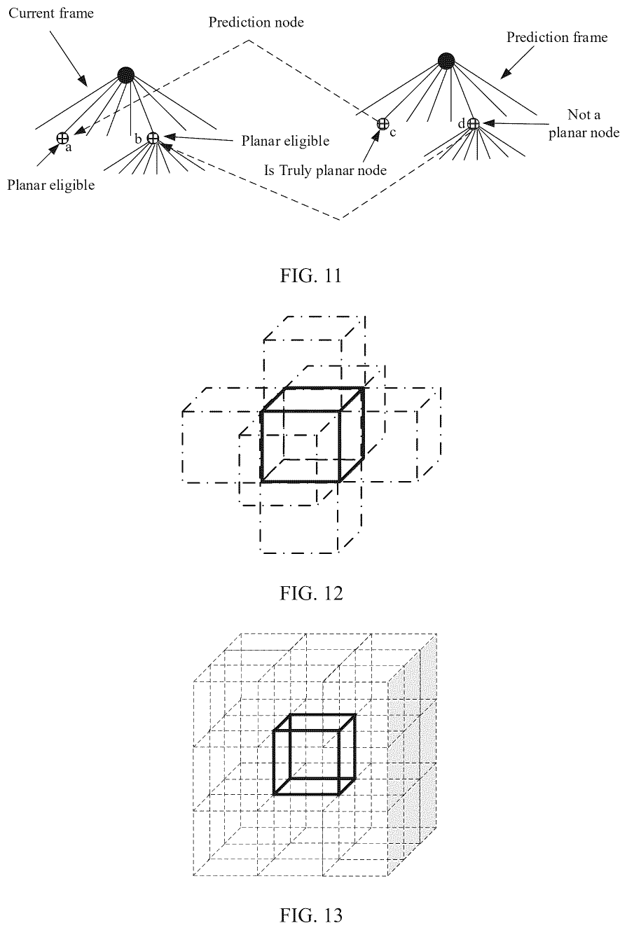

Exemplarily, FIG. 11 is a schematic diagram of inter-frame plane coding according to an embodiment of this application. As shown in FIG. 11, a current frame and a prediction frame are included herein. A node a and a node b exist in the current frame, and both the node a and the node b are planar eligible (Planar Eligible). A node c and a node d exist in the prediction frame, the node c is truly a planar node (Is Truly Planar node), and the node d is not a planar node (Not a Planar node). As may be seen from FIG. 11, the node c is a prediction node that is in the prediction frame and corresponds to a current node (that is, the node a) in the current frame. In this case, conditional enabling of plane coding may be optimized according to occupancy information of the prediction node.

In this embodiment of this application, planar structure information of the prediction node may be determined by using the occupancy information of the prediction node, and then whether a plane coding mode is enabled for the current node is directly determined by using the planar structure information of the prediction node. Therefore, in some embodiments, the method may further include: determining occupancy information of the prediction node; determining, based on the occupancy information of the prediction node, the planar structure information of the prediction node; and determining, based on the planar structure information of the prediction node, whether the plane coding mode is enabled for the current node in a preset direction.

It should be noted that the planar structure information of the prediction node may include planar mode information (PredPlanMode) of the prediction node and planar position information (PredPlanPos) of the prediction node. In a specific embodiment, the method may further include: determining the occupancy information of the prediction node; determining, based on the occupancy information of the prediction node, the planar mode information of the prediction node; and determining, based on the planar mode information of the prediction node, whether the plane coding mode is enabled for the current node in a preset direction.

In this embodiment of this application, the preset direction may be any direction in three dimensional directions, for example, an X-axis direction, a Y-axis direction, or a Z-axis direction. That is, first, whether the prediction node belongs to a real plane is determined by using the occupancy information of the prediction node. If the planar mode information of the prediction node is PredPlanMode, it may be determined, by using the planar mode information of the prediction node, whether the plane coding mode is enabled for the current node in the three dimensional directions.

It should be further noted that, in addition to the planar structure information of the prediction node, reference information of the current node may also be used to determine whether the plane coding mode is enabled for the current node. Therefore, in some embodiments, the determining, based on the planar structure information of the prediction node, whether the plane coding mode is enabled for the current node in the preset direction may include:
acquiring reference information of the current node; and
determining, based on the planar structure information of the prediction node and the reference information of the current node, whether the plane coding mode is enabled for the current node in the preset direction.

Herein, the reference information of the current node may be a condition for enabling plane coding in a related technology. For example, whether the current layer node meets a plane coding condition is determined based on a plane probability of the node in each dimension, a point cloud density of a current layer, or a collection parameter of a LiDAR point cloud. In this case, on a basis of the three conditions for enabling plane coding, inter-frame information may also be used to enrich the conditions for enabling the plane coding mode.

Briefly, in this embodiment of this application, whether to perform plane coding on the current node may be directly determined by using the planar structure information of the prediction node. In addition, both the planar structure information of the prediction node and the reference information of the current node may be used to determine whether to perform plane coding on the current node. Herein, there is no limitation on how to determine whether the plane coding mode is enabled for the current node by using the planar structure information of the prediction node.

It may be understood that, in this embodiment of this application, the preset node of the current node further includes at least one target node in addition to the prediction node of the current node in the prediction frame. The at least one target node may include a neighboring node of the prediction node, or may include a prediction node corresponding to a neighboring node of the current node. This is not specifically limited herein.

In a possible implementation, for the at least one target node, the method may further include: determining a neighboring node of the prediction node; and determining, based on the neighboring node of the prediction node, the at least one target node in the prediction frame.

Herein, the neighboring node of the prediction node may be at least one coplanar node that shares a face with the prediction node, and/or at least one co-edge node that shares an edge with the prediction node, and/or at least one co-vertex node that shares a vertex with the prediction node. Therefore, the at least one target node may include at least one of the following: at least one coplanar node that shares a face with the prediction node, at least one co-edge node that shares an edge with the prediction node, or at least one co-vertex node that shares a vertex with the prediction node.

In another possible implementation, for the at least one target node, the method may further include: determining neighboring nodes of the current node; determining, based on the prediction frame, respective prediction nodes of the neighboring nodes of the current node; and determining, based on the respective prediction nodes of the neighboring nodes of the current node, the at least one target node in the prediction frame.

Herein, the neighboring node of the current node may be at least one coplanar node that shares a face with the current node, and/or at least one co-edge node that shares an edge with the current node, and/or at least one co-vertex node that shares a vertex with the current node. Therefore, the at least one target node may also include at least one of the following: a prediction node corresponding to at least one coplanar node that shares a face with the current node, a prediction node corresponding to at least one co-edge node that shares an edge with the current node, or a prediction node corresponding to at least one co-vertex node that shares a vertex with the current node.

In this embodiment of this application, the neighboring nodes of the current node may include six coplanar neighboring nodes (which may be referred to as “coplanar nodes”), 12 co-edge neighboring nodes (which may be referred to as “co-edge nodes”), and eight co-vertex neighboring nodes (which may be referred to as “co-vertex nodes”). Herein, the neighboring nodes of the current node may include only coplanar neighboring nodes, or may include only co-edge neighboring nodes, or may include coplanar neighboring nodes and co-edge neighboring nodes, or may include coplanar neighboring nodes, co-edge neighboring nodes, and co-vertex neighboring nodes, or may include neighboring nodes in a larger reference range. This is not specifically limited herein. In consideration of a balance between coding efficiency, time complexity, memory usage, and the like, only the six coplanar neighboring nodes of the current node may be considered herein, and then corresponding prediction nodes are obtained according to the six coplanar neighboring nodes, to determine the required target node.

Exemplarily, FIG. 12 is a schematic diagram of a location relationship between a prediction node and neighboring nodes according to an embodiment of this application. As shown in FIG. 12, a node represented by a bold solid line is the prediction node, and nodes represented by dash-dotted lines are six neighboring nodes (that is, coplanar neighboring nodes, which may be referred to as “coplanar nodes” for short) that are coplanar with the prediction node. Geometric information of the prediction node may be obtained at a decoding end. Herein, occupancy information of the six neighboring nodes that are coplanar with the prediction node may be known. Therefore, the six neighboring nodes may be determined as required target nodes.

It should be further noted that, in consideration of a balance between coding efficiency, time complexity, memory usage, and the like, regarding the at least one target node, only the occupancy information of the six neighboring nodes that are coplanar with the prediction node may be considered, but a reference range of neighboring nodes is not limited herein. For example, only a coplanar neighboring node of the prediction node, or a coplanar neighboring node of the prediction node and a co-edge neighboring node of the prediction node, or a larger reference range of neighboring nodes may be referred to. No limitation is imposed herein. Exemplarily, as shown in FIG. 13, a node represented by a bold solid line is a prediction node, and nodes represented by dashed lines are neighboring nodes of the prediction node. A reference range of neighboring nodes herein is not limited to six coplanar neighboring nodes. Specifically, 6 coplanar neighboring nodes, 12 co-edge neighboring nodes, and 8 co-vertex neighboring nodes may be included herein.

In this way, after the at least one required target node is determined, the occupancy information of the preset node of the current node may be obtained according to the prediction node corresponding to the current node and the at least one target node, and then planar structure information of the preset node is determined by using the occupancy information of the preset node of the current node, to perform predictive decoding on planar position information of the current node.

S1002: Determine, based on the planar structure information of the preset node, context indication information of the current node.

It should be noted that in embodiments of this application, the context indication information of the current node may include first context indication information of the current node and second context indication information of the current node. The context indication information is calculated according to the planar structure information (for example, planar mode information and/or planar position information) of the preset node. A calculation manner herein is not limited, and how to perform the calculation is not specifically limited.

In a possible implementation, the determining, based on the planar structure information of the preset node, the context indication information of the current node may include:
determining, based on the planar structure information of the preset node, planar structure information of a first type preset node and planar structure information of a second type preset node;
determining, based on the planar structure information of the first type preset node, first context indication information of the current node; and
determining, based on the planar structure information of the second type preset node, second context indication information of the current node.

In embodiments of this application, the preset node may include the prediction node and six target nodes. Herein, the seven nodes may be classified into a first type preset node and a second type preset node. Exemplarily, the first type preset node includes the prediction node and a first target node, and the second type preset node includes a second target node. Then, the first context indication information of the current node is calculated by using the planar structure information of the first type preset node, and the second context indication information of the current node is calculated by using the planar structure information of the second type preset node.

In embodiments of this application, the first target node and the second target node may be different. Exemplarily, there are three first target nodes and three second target nodes. In an implementation, the first target node may include: a coplanar node located on the left of the prediction node, a coplanar node located in front of the prediction node, and a coplanar node located below the prediction node. The second target node may include a coplanar node located on the right of the prediction node, a coplanar node located behind the prediction node, and a coplanar node located above the prediction node. Alternatively, in another implementation, the first target node may include a prediction node corresponding to a coplanar node located on the left of the current node, a prediction node corresponding to a coplanar node located in front of the current node, and a prediction node corresponding to a coplanar node located below the current node. The second target node may include a prediction node corresponding to a coplanar node located on the right of the current node, a prediction node corresponding to a coplanar node located behind the current node, and a prediction node corresponding to a coplanar node located above the current node. However, this is not specifically limited.

In a specific embodiment, when the first type preset node includes the prediction node and a first target node, the determining the planar structure information of the first type preset node may include:
determining occupancy information of the prediction node and occupancy information of the first target node;
determining, based on the occupancy information of the prediction node, planar mode information of the prediction node and planar position information of the prediction node; and determining, based on the occupancy information of the first target node, planar mode information of the first target node and planar position information of the first target node; and
forming the planar structure information of the first type preset node according to the planar mode information of the prediction node, the planar position information of the prediction node, the planar mode information of the first target node, and the planar position information of the first target node.

Exemplarily, predictive decoding of planar position information in an X-axis direction is used as an example. It is assumed that the six target nodes are six coplanar neighboring nodes of the prediction node, occupancy information of the six coplanar neighboring nodes is respectively coPlanarLeft, coPlanarRight, coPlanarFront, coPlanarBelow, coPlanarUpper, and coPlanarDown, and the occupancy information of the prediction node is PredNode. First, occupancy information of three coplanar neighboring nodes is used to calculate planar structure information of the three coplanar neighboring nodes, including planar mode (planarMode) information and planar position (PlanePos) information. Herein, calculation of PlaneMode and PlanePos is as follows:

$$\begin{matrix}uint 8 \_t plane 0 = 0 ; \\ plane 0 = ! ! ( occupancy \& 0 \times 0 f ) << 0 ; \\ plane 0 = ! ! ( occupancy \& 0 \times 33 ) << 1 ; \\ plane 0 = ! ! ( occupancy \& 0 \times 55 ) << 2 ;\end{matrix}$$

$$\begin{matrix}uint 8 \_t plane1 = 0 ; \\ plane 1 = ! ! ( occupancy \& 0 \times 0 f ) << 0 ; \\ plane 1 = ! ! ( occupancy \& 0 \times cc ) << 1 ; \\ plane 1 = ! ! ( occupancy \& 0 \times aa ) << 2 ;\end{matrix}$$

$$// Only planar if a single plane normal to an axis is occupied$$

$$planarMode = plane 0 \hat{} plane 1 ;$$

$$PlanePos = planarMode \& plane 1 ;$$

In this way, it is assumed that the first target node includes three coplanar neighboring nodes of the prediction node, and occupancy information of the three coplanar neighboring nodes is respectively coPlanarLeft, coPlanarFront, and coPlanarDown. First, the occupancy information of the three coplanar neighboring nodes and the occupancy information of the prediction node are used to calculate the planar structure information of the first type preset node, represented as PredNodePlaneMode, PredNodePlanePos, coPlanarLeftPlaneMode, coPlanarLeftPlanePos, coPlanarFrontPlaneMode, coPlanarFrontPlanePos, coPlanarDownPlaneMode, and coPlanarDownPlanePos.

Further, the determining, based on the planar structure information of the first type preset node, the first context indication information of the current node may include: determining, based on the planar mode information of the prediction node, the planar position information of the prediction node, the planar mode information of the first target node, and the planar position information of the first target node, the first context indication information of the current node.

It should be further noted that, assuming that the first context indication information of the current node may be represented by Ctx1, after the planar structure information of the first type preset node is determined, Ctx1 may be calculated by using the planar structure information of the first type preset node. Details are as follows:

$$Const int mask = 1 << axisIdx ( axisIdx = 0 ( x ) , 1 ( y ) , 2 ( z ) ) \qquad ( 3 )$$

$$\begin{matrix}Ctx 1 = ! ! ( PredNodePlanePos \& mask ) << 7 \vert \\ ! ! ( PredNodePlaneMode \& mask ) << 6 \vert \\ ! ! ( coPlanarLeftPlanePos \& mask ) << 5 \vert \\ ! ! ( coPlanarFrontPlanePos \& mask ) << 4 \vert \\ ! ! ( coPlanarDownPlanePos \& mask ) << 3 \vert \\ ! ! ( coPlanarLeftPlaneMode \& mask ) << 2 \vert \\ ! ! ( coPlanarFrontPlaneMode \& mask ) << 1 \vert \\ ! ! ( coPlanarDownPlaneMode \& mask )\end{matrix}$$

In another specific embodiment, when the second type preset node includes a second target node, the determining the planar structure information of the second type preset node may include:
determining occupancy information of the second target node;
determining, based on the occupancy information of the second target node, planar mode information of the second target node and planar position information of the second target node; and
forming the planar structure information of the second type preset node according to the planar mode information of the second target node and the planar position information of the second target node.

It should be noted that, it is assumed that the second target node includes the other three coplanar neighboring nodes of the prediction node, and occupancy information of the three coplanar neighboring nodes is respectively coEdgerRight, coEdgerUpper, and coEdgerBelow. First, the occupancy information of the three coplanar neighboring nodes is used to calculate the planar structure information of the second type preset node, represented as coPlanarRightPlaneMode, coPlanarRightPlanePos, coPlanarUpperPlaneMode, coPlanarUpperPlanePos, coPlanarBelowPlaneMode, and coPlanarBelowPlanePos.

Further, the determining, based on the planar structure information of the second type preset node, the second context indication information of the current node may include: determining, based on the planar mode information of the second target node and the planar position information of the second target node, the second context indication information of the current node.

It should be further noted that, assuming that the second context indication information of the current node may be represented by Ctx2, after the planar structure information of the second type preset node is determined, Ctx2 may be calculated by using the planar structure information of the second type preset node. Details are as follows:

$$\begin{matrix}Ctx 2 = ! ! ( coPlanarRightPlanePos \& mask ) << 5 \vert \\ ! ! ( coPlanarUpperPlanePos \& mask ) << 4 \vert \\ ! ! ( coPlanarBelowPlanePos \& mask ) << 3 \vert \\ ! ! ( coPlanarRightPlaneMode \& mask ) << 2 \vert \\ ! ! ( coPlanarUpperPlaneMode \& mask ) << 1 \vert \\ ! ! ( coPlanarBelowPlaneMode \& mask )\end{matrix} \qquad ( 4 )$$

In embodiments of this application, “<<” represents a left shift operator. For example, “<<n” represents shifting leftward by n bits, and indicates multiplying by 2ⁿ in a multiplication operation. “!!” is usually used to determine a type, and represents double negation, that is, a negated value is negated again. “|” represents a bit operator, and is specifically bitwise OR herein. “&” represents a bit operator, and is specifically bitwise AND herein. “a|=b” indicates a=a|b, that is, the bitwise OR operation is performed on a and b and then the obtained value is assigned to a.

In the foregoing implementation, the first target node and the second target node may be several nodes in the six coplanar neighboring nodes. A manner of acquiring the six coplanar neighboring nodes may be as follows. First, the prediction node of the prediction frame is obtained by using the current node, and then six coplanar neighboring nodes that are coplanar with the prediction node are obtained by using the prediction node. Alternatively, first, six coplanar neighboring nodes of the current node in the current frame are obtained, and then corresponding prediction nodes are obtained by using the six coplanar neighboring nodes and are used as final six coplanar neighboring nodes. Although prediction nodes obtained in the two acquisition manners may be different, this is not specifically limited in embodiments of this application.

In another possible implementation, the determining, based on the planar structure information of the preset node, the context indication information of the current node may include:
determining, based on the planar structure information of the preset node, a first type planar structure information of the preset node and a second type planar structure information of the preset node;
determining, based on the first type planar structure information of the preset node, first context indication information of the current node; and
determining, based on the second type planar structure information of the preset node, second context indication information of the current node.

It should be noted that in embodiments of this application, the preset node may include the prediction node and six target nodes. Exemplarily, the first context indication information may be calculated by using planar position information of the seven nodes, and the second context indication information may be calculated by using planar mode information of the seven nodes.

It should be further noted that, in embodiments of this application, there are six third target nodes, which may specifically be six coplanar neighboring nodes. Exemplarily, in an implementation, the third target nodes may include a coplanar node located on the left of the prediction node, a coplanar node located in front of the prediction node, a coplanar node located below the prediction node, a coplanar node located on the right of the prediction node, a coplanar node located behind the prediction node, and a coplanar node located above the prediction node. Alternatively, in another implementation, the third target nodes may include: a prediction node corresponding to a coplanar node located on the left of the current node, a prediction node corresponding to a coplanar node located in front of the current node, a prediction node corresponding to a coplanar node located below the current node, a prediction node corresponding to a coplanar node located on the right of the current node, a prediction node corresponding to a coplanar node located behind the current node, and a prediction node corresponding to a coplanar node located above the current node. However, this is not specifically limited.

In a specific embodiment, when the preset node includes the prediction node and the third target node, the determining the first type planar structure information of the preset node may include:
determining occupancy information of the prediction node and occupancy information of the third target node;
determining, based on the occupancy information of the prediction node and the occupancy information of the third target node, planar position information of the prediction node and planar position information of the third target node; and
forming the first type planar structure information of the preset node according to the planar position information of the prediction node and the planar position information of the third target node.

Further, the determining, based on the first type planar structure information of the preset node, the first context indication information of the current node may include: determining, based on the planar position information of the prediction node and planar position information of the third target node, the first context indication information of the current node.

In embodiments of this application, assuming that the third target nodes are six coplanar neighboring nodes, the first type planar structure information of the preset node may include: PredNodePlanePos, coPlanarLeftPlanePos, coPlanarDownPlanePos, coPlanarFrontPlanePos, coPlanarRightPlanePos, coPlanarUpperPlanePos, and coPlanarBelowPlanePos.

In this case, the first context indication information of the current node may be represented by Ctx1. After the planar position information of the preset node is determined, Ctx1 may be calculated by using the planar position information of the preset node. Details are as follows:

$$Const int mask = 1 << axisIdx ( axisIdx = 0 ( x ) , 1 ( y ) , 2 ( z ) ) \qquad ( 5 )$$

$$\begin{matrix}Ctx 1 = ! ! ( PredNodePlanePos \& mask ) << 6 \vert \\ ! ! ( coPlanarLeftPlanePos \& mask ) << 5 \vert \\ ! ! ( coPlanarFrontPlanePos \& mask ) << 4 \vert \\ ! ! ( coPlanarDownPlanePos \& mask ) << 3 \vert \\ ! ! ( coPlanarRightPlanePos \& mask ) << 2 \vert \\ ! ! ( coPlanarUpperPlanePos \& mask ) << 1 \\ ! ! ( coPlanarBelowPlanePos \& mask )\end{matrix}$$

In another specific embodiment, when the preset node includes the prediction node and the third target node, the determining the second type planar structure information of the preset node may include:
determining occupancy information of the prediction node and occupancy information of the third target node;
determining, based on the occupancy information of the prediction node and the occupancy information of the third target node, planar mode information of the prediction node and planar mode information of the third target node; and
forming the second type planar structure information of the preset node according to the planar mode information of the prediction node and the planar mode information of the third target node.

Further, the determining, based on the second type planar structure information of the preset node, the second context indication information of the current node may include: determining, based on the planar mode information of the prediction node and the planar mode information of the third target node, the second context indication information of the current node.

In embodiments of this application, assuming that the third target nodes are six coplanar neighboring nodes, the second type planar structure information of the preset node may include: coPlanarLeftPlaneMode, coPlanarDownPlaneMode, PredNodePlaneMode, coPlanarFrontPlaneMode, coPlanarRightPlaneMode, coPlanarUpperPlaneMode, and coPlanarBelowPlaneMode.

In this case, the second context indication information of the current node may be represented by Ctx2. After the planar mode information of the preset node is determined, Ctx2 may be calculated by using the planar mode information of the preset node. Details are as follows:

$$\begin{matrix}Ctx 2 = ! ! ( PredNodePlaneMode \& mask ) << 6 \vert \\ ! ! ( coPlanarLeftPlaneMode \& mask ) << 5 \vert \\ ! ! ( coPlanarFrontPlaneMode \& mask ) << 4 \vert \\ ! ! ( coPlanarDownPlaneMode \& mask ) << 3 \vert \\ ! ! ( coPlanarRightPlaneMode \& mask ) << 2 \vert \\ ! ! ( coPlanarUpperPlaneMode \& mask ) << 1 \\ ! ! ( coPlanarBelowPlaneMode \& mask )\end{matrix} \qquad ( 6 )$$

That is, in the foregoing implementation, Ctx1 may be calculated by using planar mode information and planar position information of the prediction node and three coplanar neighboring nodes that are respectively on the left of the prediction node, in front of the prediction node, and below the prediction node, and Ctx2 may be calculated by using planar mode information and planar position information of three coplanar neighboring nodes that are respectively on the right of the prediction node, behind the prediction node, and above the prediction node. Alternatively, Ctx1 may be calculated by using planar position information of the seven nodes, including the prediction node and the six coplanar neighboring nodes, and Ctx2 may be calculated by using planar mode information of the seven nodes, including the prediction node and the six coplanar neighboring nodes. Herein, although only two manners of calculating Ctx1 and Ctx2 by using planar structure information of neighboring nodes are provided, calculation of Ctx1 and Ctx2 is not limited in embodiments of this application. For example, in embodiments of this application, Ctx1 and Ctx2 may be inferred by using occupancy information of neighboring nodes, and how to perform the calculation is not specifically limited.

S1003: Determine, based on the context indication information, target context information.

S1004: Decode a bitstream based on the target context information, to determine planar position information of the current node.

It should be noted that, in embodiments of this application, first, the target context information needs to be determined, and then the planar position information of the current node can be decoded by using the target context information. In some embodiments, the determining, based on the context indication information, the target context information may include:
acquiring the first context indication information of the current node and the second context indication information of the current node; and
determining, based on the first context indication information and the second context indication information, the target context information.

That is, after Ctx1 and Ctx2 are calculated by using the planar structure information of the neighboring node, the target context information may be determined based on Ctx1 and Ctx2. Further, in embodiments of this application, context mapping processing may be performed on Ctx1 and Ctx2, to determine the target context information. Therefore, in some embodiments, the determining, based on the first context indication information and the second context indication information, the target context information may include:
performing context mapping processing according to the first context indication information and the second context indication information, to obtain new context information; and determining, based on the new context information, the target context information.

It should be further noted that, in embodiments of this application, Ctx1 and Ctx2 may be directly calculated by performing a simple AND or OR operation by using planar structure information of a plurality of neighboring nodes that are coplanar, co-edge, or co-vertex with the prediction node, to finally determine the target context information. In addition, in embodiments of this application, the target context information that is finally used for decoding is not limited. For example, Ctx1 and Ctx2 may be mapped, in some manners such as spatial rotation invariance or context mapping, to obtain the new context information and determine the target context information. This is not specifically limited herein.

In some embodiments, the determining, based on the context indication information, the target context information may include:
determining reference context information of the current node; and
determining, based on the first context indication information, the second context indication information, and the reference context information, the target context information.

Further, for existing reference context information, in some embodiments, the determining the reference context information of the current node includes at least one of the following:
performing prediction, based on occupancy information of the neighboring node, to determine a predicted value of the planar position information of the current node, where the predicted value includes one of the following: being a low plane, being a high plane, or being unpredictable;
determining a spatial distance between the current node and a node at a same partitioning depth and a same coordinate as the current node, where the spatial distance includes one of the following: a short distance or a long distance;
determining whether the node at the same partitioning depth and the same coordinate as the current node is a plane, and if the node is a plane, determining a planar position of the node; or
determining coordinate dimension information of the current node.

It should be noted that, in embodiments of this application, after the spatial distance between the current node and the node at the same partitioning depth and the same coordinate as the current node is determined, if the spatial distance is less than a preset distance threshold, it may be determined that the spatial distance is a short distance. Alternatively, if the spatial distance is greater than the preset distance threshold, it may be determined that the spatial distance is a long distance.

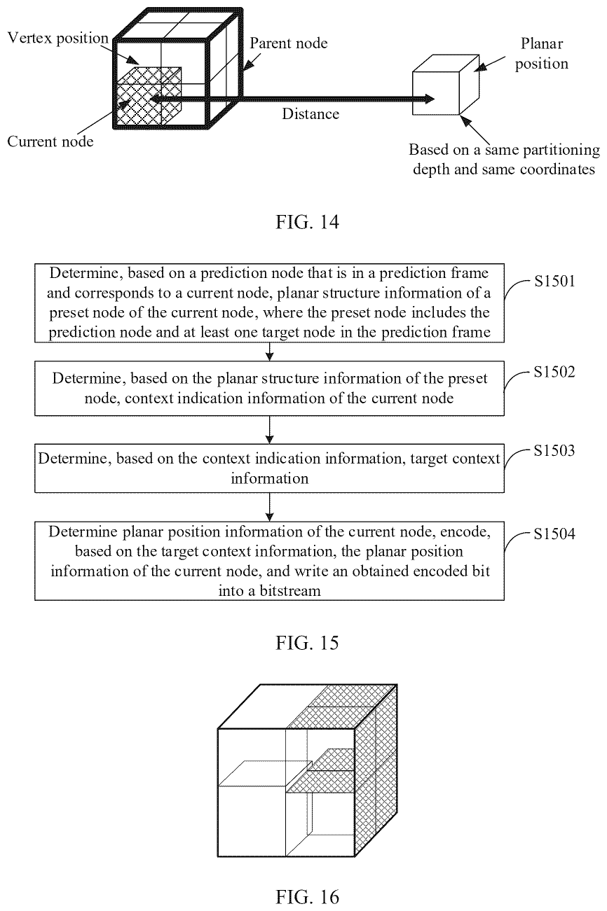

Exemplarily, FIG. 14 is a schematic diagram of a neighboring node at a same partitioning depth and a same coordinate according to an embodiment of this application. As shown in FIG. 14, a bold large cube represents a parent node (Parent node), a grid-filled small cube inside the large cube represents a current node (Current node), and a vertex position (Vertex position) of the current node is shown. A small cube filled with the white color represents a neighboring node at a same partitioning depth and a same coordinate. A distance between the current node and the neighboring node is a spatial distance, which may be determined as a “short distance” or a “long distance”. In addition, if the neighboring node is a plane, a planar position (Planar position) of the neighboring node is also required.

In this case, the target context information that is finally used for planar position information may be as follows:
(a) planar position information of the current node that is obtained through prediction by using occupancy information of the neighboring node, which includes three elements, namely, being predicted as a low plane, being predicted as a high plane, and being unpredictable;
(b) the spatial distance between the current node and the node at the same partitioning depth and the same coordinate as the current node, which is a “short distance” or a “long distance”;
(c) if the node at the same partitioning depth and the same coordinate as the current node is a plane, the planar position of the node is determined;
(d) coordinate dimensions of the current node (i=0, 1, 2);
(e) Ctx1, which, for example, is calculated by using planar structure information of a prediction node and three coplanar neighboring nodes that are respectively on the left of the prediction node, in front of the prediction node, and below the prediction node; and
(f) Ctx2, which, for example, is calculated by using planar structure information of three coplanar neighboring nodes that are respectively on the right of the prediction node, behind the prediction node, and above the prediction node.

That is, in this embodiment of this application, planar structure information of a prediction node and six coplanar neighboring nodes may be determined by using occupancy information of coplanar neighboring nodes shown in FIG. 12. Then, a context Ctx1 and a context Ctx2 of planar position information of a current node are calculated by using the planar structure information of the seven nodes. Finally, the planar position information of the current node is decoded by using Ctx1, Ctx2, and existing reference context information.

An embodiment of this application provides a decoding method. Planar structure information of a preset node of a current node is determined based on a prediction node that is in a prediction frame and corresponds to the current node, where the preset node includes the prediction node and at least one target node in the prediction frame; context indication information of the current node is determined based on the planar structure information of the preset node; target context information is determined based on the context indication information; and a bitstream is decoded based on the target context information, to determine planar position information of the current node. In this way, in a process of decoding the planar position information of the current node by using the target context information, correlation between planar structure information of corresponding nodes in adjacent prediction frames is considered, and time domain correlation between the adjacent prediction frames is used to remove redundancy of planar structure information between the adjacent frames, thereby improving coding efficiency of geometric information of a point cloud, and improving encoding and decoding performance of the point cloud.

In another embodiment of this application, FIG. 15 is a schematic flowchart of an encoding method according to this embodiment of this application. As shown in FIG. 15, the method may include the following steps.

S1501: Determine, based on a prediction node that is in a prediction frame and corresponds to a current node, planar structure information of a preset node of the current node, where the preset node includes the prediction node and at least one target node in the prediction frame.

It should be noted that the encoding method according to this embodiment of this application is applied to an encoder. In addition, the encoding method may refer to a point cloud geometry encoding method, which is specifically an inter-frame plane coding method, and more specifically, a method for determining context information based on a point cloud plane coding mode. Then, planar position information of a current node is encoded according to determined target context information.

It should be further noted that, points in a point cloud may be all points in the point cloud, or may be some points in the point cloud, which are relatively concentrated in space. Herein, the current node specifically refers to a node that is in the point cloud and is currently to be encoded.

In this embodiment of this application, the prediction frame is an encoded frame, and the prediction frame is adjacent to a current frame that includes the current node. That is, the prediction frame is an encoded reference frame adjacent to the current frame, and time domain correlation of nodes between adjacent prediction frames may be used, thereby improving plane coding efficiency of the current node.

In this embodiment of this application, specifically referring to FIG. 11, conditional enabling of plane coding may be optimized according to occupancy information of the prediction node. That is, planar structure information of the prediction node may be determined by using the occupancy information of the prediction node, and then whether a plane coding mode is enabled for the current node is directly determined by using the planar structure information of the prediction node. Therefore, in some embodiments, the method may further include: determining the occupancy information of the prediction node; determining, based on the occupancy information of the prediction node, the planar structure information of the prediction node; and determining, based on the planar structure information of the prediction node, whether the plane coding mode is enabled for the current node in a preset direction.

It should be noted that the planar structure information of the prediction node may include planar mode information (PredPlanMode) of the prediction node and planar position information (PredPlanPos) of the prediction node. In a specific embodiment, the method may further include: determining the occupancy information of the prediction node; determining, based on the occupancy information of the prediction node, the planar mode information of the prediction node; and determining, based on the planar mode information of the prediction node, whether the plane coding mode is enabled for the current node in a preset direction.

In this embodiment of this application, the preset direction may be any direction in three dimensional directions, for example, an X-axis direction, a Y-axis direction, or a Z-axis direction. That is, first, whether the prediction node belongs to a real plane is determined by using the occupancy information of the prediction node. If the planar mode information of the prediction node is PredPlanMode, it may be determined, by using the planar mode information of the prediction node, whether the plane coding mode is enabled for the current node in the three dimensional directions.

It should be further noted that, in addition to the planar structure information of the prediction node, reference information of the current node may also be used to determine whether the plane coding mode is enabled for the current node. Therefore, in some embodiments, the determining, based on the planar structure information of the prediction node, whether the plane coding mode is enabled for the current node in the preset direction may include:
acquiring reference information of the current node; and
determining, based on the planar structure information of the prediction node and the reference information of the current node, whether the plane coding mode is enabled for the current node in the preset direction.

Herein, the reference information of the current node may be a condition for enabling plane coding in a related technology. For example, whether the current layer node meets a plane coding condition is determined based on a plane probability of the node in each dimension, a point cloud density of a current layer, or a collection parameter of a LiDAR point cloud. In this case, on a basis of the three conditions for enabling plane coding, inter-frame information may also be used to enrich the conditions for enabling the plane coding mode.

Briefly, in this embodiment of this application, whether to perform plane coding on the current node may be directly determined by using the planar structure information of the prediction node. In addition, both the planar structure information of the prediction node and the reference information of the current node may be used to determine whether to perform plane coding on the current node. Herein, there is no limitation on how to determine whether the plane coding mode is enabled for the current node by using the planar structure information of the prediction node.

It may be understood that, in this embodiment of this application, the preset node of the current node further includes at least one target node in addition to the prediction node of the current node in the prediction frame. The at least one target node may include a neighboring node of the prediction node, or may include a prediction node corresponding to a neighboring node of the current node. This is not specifically limited herein.

In a possible implementation, for the at least one target node, the method may further include: determining a neighboring node of the prediction node; and determining, based on the neighboring node of the prediction node, the at least one target node in the prediction frame.

Herein, the neighboring node of the prediction node may be at least one coplanar node that shares a face with the prediction node, and/or at least one co-edge node that shares an edge with the prediction node, and/or at least one co-vertex node that shares a vertex with the prediction node. Therefore, the at least one target node may include at least one of the following: at least one coplanar node that shares a face with the prediction node, at least one co-edge node that shares an edge with the prediction node, or at least one co-vertex node that shares a vertex with the prediction node.

In another possible implementation, for the at least one target node, the method may further include: determining neighboring nodes of the current node; determining, based on the prediction frame, respective prediction nodes of the neighboring nodes of the current node; and determining, based on the respective prediction nodes of the neighboring nodes of the current node, the at least one target node in the prediction frame.

Herein, the neighboring node of the current node may be at least one coplanar node that shares a face with the current node, and/or at least one co-edge node that shares an edge with the current node, and/or at least one co-vertex node that shares a vertex with the current node. Therefore, the at least one target node may also include at least one of the following: a prediction node corresponding to at least one coplanar node that shares a face with the current node, a prediction node corresponding to at least one co-edge node that shares an edge with the current node, or a prediction node corresponding to at least one co-vertex node that shares a vertex with the current node.

In this embodiment of this application, the neighboring nodes of the current node may include six coplanar neighboring nodes, 12 co-edge neighboring nodes, and eight co-vertex neighboring nodes. Herein, the neighboring nodes of the current node may include only coplanar neighboring nodes, or may include only co-edge neighboring nodes, or may include coplanar neighboring nodes and co-edge neighboring nodes, or may include coplanar neighboring nodes, co-edge neighboring nodes, and co-vertex neighboring nodes, or may be a larger reference range of neighboring nodes. This is not specifically limited herein. In consideration of a balance between coding efficiency, time complexity, memory usage, and the like, only the six coplanar neighboring nodes of the current node may be considered herein, and then corresponding prediction nodes are obtained according to the six coplanar neighboring nodes, to determine the required target node.

In this embodiment of this application, the geometric information of the prediction node can be obtained at an encoding end, and occupancy information of the six neighboring nodes that are coplanar with the prediction node can be known. Therefore, the six neighboring nodes may be determined as required target nodes. In consideration of a balance between coding efficiency, time complexity, memory usage, and the like, regarding the at least one target node, only the occupancy information of the six neighboring nodes that are coplanar with the prediction node may be considered, but a reference range of neighboring nodes is not limited herein. For example, only a coplanar neighboring node of the prediction node, or a coplanar neighboring node of the prediction node and a co-edge neighboring node of the prediction node, or a larger reference range of neighboring nodes may be referred to. No limitation is imposed herein.

In this way, after the at least one required target node is determined, the occupancy information of the preset node of the current node may be obtained according to the prediction node corresponding to the current node and the at least one target node, and then planar structure information of the preset node is determined by using the occupancy information of the preset node of the current node, to perform predictive encoding on planar position information of the current node.

S1502: Determine, based on the planar structure information of the preset node, context indication information of the current node.

It should be noted that in embodiments of this application, the context indication information of the current node may include first context indication information of the current node and second context indication information of the current node. The context indication information is calculated according to the planar structure information (for example, planar mode information and/or planar position information) of the preset node. A calculation manner herein is not limited, and how to perform the calculation is not specifically limited.

In a possible implementation, the determining, based on the planar structure information of the preset node, the context indication information of the current node may include:
determining, based on the planar structure information of the preset node, planar structure information of a first type preset node and planar structure information of a second type preset node;
determining, based on the planar structure information of the first type preset node, first context indication information of the current node; and
determining, based on the planar structure information of the second type preset node, second context indication information of the current node.

In embodiments of this application, the preset node may include the prediction node and six target nodes. Herein, the seven nodes may be classified into a first type preset node and a second type preset node. Exemplarily, the first type preset node includes the prediction node and a first target node, and the second type preset node includes a second target node. Then, the first context indication information of the current node is calculated by using the planar structure information of the first type preset node, and the second context indication information of the current node is calculated by using the planar structure information of the second type preset node.

In embodiments of this application, the first target node and the second target node may be different. Exemplarily, there are three first target nodes and three second target nodes. In an implementation, the first target node may include: a coplanar node located on the left of the prediction node, a coplanar node located in front of the prediction node, and a coplanar node located below the prediction node. The second target node may include a coplanar node located on the right of the prediction node, a coplanar node located behind the prediction node, and a coplanar node located above the prediction node. Alternatively, in another implementation, the first target node may include a prediction node corresponding to a coplanar node located on the left of the current node, a prediction node corresponding to a coplanar node located in front of the current node, and a prediction node corresponding to a coplanar node located below the current node. The second target node may include a prediction node corresponding to a coplanar node located on the right of the current node, a prediction node corresponding to a coplanar node located behind the current node, and a prediction node corresponding to a coplanar node located above the current node. However, this is not specifically limited.

In a specific embodiment, when the first type preset node includes the prediction node and a first target node, the determining the planar structure information of the first type preset node may include:
determining occupancy information of the prediction node and occupancy information of the first target node;
determining, based on the occupancy information of the prediction node, planar mode information of the prediction node and planar position information of the prediction node; and determining, based on the occupancy information of the first target node, planar mode information of the first target node and planar position information of the first target node; and
forming the planar structure information of the first type preset node according to the planar mode information of the prediction node, the planar position information of the prediction node, the planar mode information of the first target node, and the planar position information of the first target node.

Further, the determining, based on the planar structure information of the first type preset node, the first context indication information of the current node may include: determining, based on the planar mode information of the prediction node, the planar position information of the prediction node, the planar mode information of the first target node, and the planar position information of the first target node, the first context indication information of the current node.

In this embodiment of this application, it is assumed that the first target node is three coplanar neighboring nodes of the prediction node, and occupancy information of the three coplanar neighboring nodes and the occupancy information of the prediction node are used to calculate the planar structure information of the first type preset node, represented as PredNodePlaneMode, PredNodePlanePos, coPlanarLeftPlaneMode, coPlanarLeftPlanePos, coPlanarFrontPlaneMode, coPlanarFrontPlanePos, coPlanarDownPlaneMode, and coPlanarDownPlanePos. Then, the first context indication information (represented by Ctx1) of the current node is calculated by using the planar structure information of the first type preset node. For calculation of Ctx1, refer to a calculation process of a decoding end. For details, refer to the formula (3). Details are not described herein again.

In another specific embodiment, when the second type preset node includes the second target node, the determining the planar structure information of the second type preset node may include:
determining occupancy information of the second target node;
determining, based on the occupancy information of the second target node, planar mode information of the second target node and planar position information of the second target node; and
forming the planar structure information of the second type preset node according to the planar mode information of the second target node and the planar position information of the second target node.

Further, the determining, based on the planar structure information of the second type preset node, the second context indication information of the current node may include: determining, based on the planar mode information of the second target node and the planar position information of the second target node, the second context indication information of the current node.

In this embodiment of this application, it is assumed that the second target node is the other three coplanar neighboring nodes of the prediction node, and occupancy information of the three coplanar neighboring nodes is used to calculate the planar structure information of the second type preset node, represented as coPlanarRightPlaneMode, coPlanarRightPlanePos, coPlanarUpperPlaneMode, coPlanarUpperPlanePos, coPlanarBelowPlaneMode, and coPlanarBelowPlanePos. Then, the second context indication information (represented by Ctx2) of the current node is calculated by using the planar structure information of the second type preset node. For calculation of Ctx2, refer to a calculation process of a decoding end. For details, refer to the formula (4). Details are not described herein again.

In addition, in the foregoing implementation, the first target node and the second target node may be several nodes in the six coplanar neighboring nodes. A manner of acquiring the six coplanar neighboring nodes may be as follows. First, the prediction node of the prediction frame is obtained by using the current node, and then six coplanar neighboring nodes that are coplanar with the prediction node are obtained by using the prediction node. Alternatively, first, six coplanar neighboring nodes of the current node in the current frame are obtained, and then corresponding prediction nodes are obtained by using the six coplanar neighboring nodes and are used as final six coplanar neighboring nodes. Although prediction nodes obtained in the two acquisition manners may be different, this is not specifically limited in embodiments of this application.

In another possible implementation, the determining, based on the planar structure information of the preset node, the context indication information of the current node may include:
determining, based on the planar structure information of the preset node, a first type planar structure information of the preset node and a second type planar structure information of the preset node;
determining, based on the first type planar structure information of the preset node, first context indication information of the current node; and
determining, based on the second type planar structure information of the preset node, second context indication information of the current node.

It should be noted that in embodiments of this application, the preset node may include the prediction node and six target nodes. Exemplarily, the first context indication information may be calculated by using planar position information of the seven nodes, and the second context indication information may be calculated by using planar mode information of the seven nodes.

It should be further noted that, in embodiments of this application, there are six third target nodes, which may specifically be six coplanar neighboring nodes. Exemplarily, in an implementation, the third target nodes may include a coplanar node located on the left of the prediction node, a coplanar node located in front of the prediction node, a coplanar node located below the prediction node, a coplanar node located on the right of the prediction node, a coplanar node located behind the prediction node, and a coplanar node located above the prediction node. Alternatively, in another implementation, the third target nodes may include: a prediction node corresponding to a coplanar node located on the left of the current node, a prediction node corresponding to a coplanar node located in front of the current node, a prediction node corresponding to a coplanar node located below the current node, a prediction node corresponding to a coplanar node located on the right of the current node, a prediction node corresponding to a coplanar node located behind the current node, and a prediction node corresponding to a coplanar node located above the current node. However, this is not specifically limited.

In a specific embodiment, when the preset node includes the prediction node and the third target node, the determining the first type planar structure information of the preset node may include:
determining occupancy information of the prediction node and occupancy information of the third target node;
determining, based on the occupancy information of the prediction node and the occupancy information of the third target node, planar position information of the prediction node and planar position information of the third target node; and
forming the first type planar structure information of the preset node according to the planar position information of the prediction node and the planar position information of the third target node.

Further, the determining, based on the first type planar structure information of the preset node, the first context indication information of the current node may include: determining, based on the planar mode information of the prediction node and planar position information of the third target node, the first context indication information of the current node.

In this embodiment of this application, assuming that the third target nodes are six coplanar neighboring nodes, the first type planar structure information of the preset node may include: PredNodePlanePos, coPlanarLeftPlanePos, coPlanarDownPlanePos, coPlanarFrontPlanePos, coPlanarRightPlanePos, coPlanarUpperPlanePos, and coPlanarBelowPlanePos. Then, the first context indication information (represented by Ctx1) of the current node is calculated by using planar position information of the preset node. For calculation of Ctx1, refer to a calculation process of a decoding end. For details, refer to the formula (5). Details are not described herein again.

In another specific embodiment, when the preset node includes the prediction node and the third target node, the determining the second type planar structure information of the preset node may include:
determining occupancy information of the prediction node and occupancy information of the third target node;
determining, based on the occupancy information of the prediction node and the occupancy information of the third target node, planar mode information of the prediction node and planar mode information of the third target node; and
forming the second type planar structure information of the preset node according to the planar mode information of the prediction node and the planar mode information of the third target node.

Further, the determining, based on the second type planar structure information of the preset node, the second context indication information of the current node may include: determining, based on the planar mode information of the prediction node and the planar mode information of the third target node, the second context indication information of the current node.

In this embodiment of this application, assuming that the third target nodes are six coplanar neighboring nodes, the second type planar structure information of the preset node may include: PredNodePlaneMode, coPlanarLeftPlaneMode, coPlanarDownPlaneMode, coPlanarFrontPlaneMode, coPlanarRightPlaneMode, coPlanarUpperPlaneMode, and coPlanarBelowPlaneMode. Then, the second context indication information (represented by Ctx2) of the current node is calculated by using planar mode information of the preset node. For calculation of Ctx2, refer to a calculation process of a decoding end. For details, refer to the formula (6). Details are not described herein again.

That is, in the foregoing implementation, Ctx1 may be calculated by using planar mode information and planar position information of the prediction node and three coplanar neighboring nodes that are respectively on the left of the prediction node, in front of the prediction node, and below the prediction node, and Ctx2 may be calculated by using planar mode information and planar position information of three coplanar neighboring nodes that are respectively on the right of the prediction node, behind the prediction node, and above the prediction node. Alternatively, Ctx1 may be calculated by using planar position information of the seven nodes, including the prediction node and the six coplanar neighboring nodes, and Ctx2 may be calculated by using planar mode information of the seven nodes, including the prediction node and the six coplanar neighboring nodes. Herein, although only two manners of calculating Ctx1 and Ctx2 by using planar structure information of neighboring nodes are provided, calculation of Ctx1 and Ctx2 is not limited in embodiments of this application. For example, in embodiments of this application, Ctx1 and Ctx2 may be inferred by using occupancy information of neighboring nodes, and how to perform the calculation is not specifically limited.

S1503: Determine, based on the context indication information, target context information.

S1504: Determine planar position information of the current node, encode, based on the target context information, the planar position information of the current node, and write an encoded bit into a bitstream.

It should be noted that, in this embodiment of this application, not only the target context information needs to be determined, but also the planar position information of the current node needs to be determined. Then, the target context information can be used to encode the planar position information of the current node. In some embodiments, the determining the planar position information of the current node may include:
when the current node meets a plane coding condition, determining that the planar position information of the current node is one of the following: low planar position information or high planar position information.

In this embodiment of this application, whether the current node meets the plane coding condition may be determined based on a plane probability of the node in each dimension, a point cloud density of a current layer, a collection parameter of a LiDAR point cloud, or the like. In addition, in this embodiment of this application, whether the current node meets the plane coding condition may be determined based on the planar structure information (for example, the planar mode information PredPlanMode) of the prediction node, to determine whether plane coding is enabled for the current node in a preset direction. This is not specifically limited herein.

In some embodiments, the determining, based on the context indication information, the target context information may include:
acquiring the first context indication information of the current node and the second context indication information of the current node; and
determining, based on the first context indication information and the second context indication information, the target context information.

That is, after Ctx1 and Ctx2 are calculated by using the planar structure information of the neighboring node, the target context information may be determined based on Ctx1 and Ctx2. Further, in embodiments of this application, context mapping processing may be performed on Ctx1 and Ctx2, to determine the target context information. Therefore, in some embodiments, the determining, based on the first context indication information and the second context indication information, the target context information may include:

performing context mapping processing according to the first context indication information and the second context indication information, to obtain new context information; and determining, based on the new context information, the target context information.

It should be further noted that, in embodiments of this application, Ctx1 and Ctx2 may be directly calculated by performing a simple AND or OR operation by using planar structure information of a plurality of neighboring nodes that are coplanar, co-edge, or co-vertex with the prediction node, to finally determine the target context information. In addition, in this embodiment of this application, the target context information that is finally used for encoding is not limited. For example, Ctx1 and Ctx2 may be mapped, in some manners such as spatial rotation invariance or context mapping, to obtain the new context information and determine the target context information. This is not specifically limited herein.

In some embodiments, the determining, based on the context indication information, the target context information may include:
determining reference context information of the current node; and
determining, based on the first context indication information, the second context indication information, and the reference context information, the target context information.

It should be noted that, in this embodiment of this application, the target context information may be determined based on Ctx1, Ctx2, and the reference context information, or Ctx1 and Ctx2 may be mapped to obtain the new context information, and then the target context information is determined based on the new context information and the reference context information. The finally used target context information is not limited herein.

It should be further noted that, in this embodiment of this application, the target context information herein may be a target context index value, and then a corresponding context model is determined based on the target context index value, and the planar position information of the current node is encoded by using the context model. Alternatively, the target context information herein may be a finally determined context model, and then the planar position information of the current node is encoded by using the context model.

Further, for existing reference context information, in some embodiments, the determining the reference context information of the current node includes at least one of the following:
performing prediction, based on occupancy information of the neighboring node, to determine a predicted value of the planar position information of the current node, where the predicted value includes one of the following: being a low plane, being a high plane, or being unpredictable;
determining a spatial distance between the current node and a node at a same partitioning depth and a same coordinate as the current node, where the spatial distance meets one of the following: a short distance or a long distance;
determining whether the node at the same partitioning depth and the same coordinate as the current node is a plane, and if the node is a plane, determining a planar position of the node; or
determining coordinate dimension information of the current node.

It should be noted that, for the current node, a neighboring node may be searched for at a same octree partitioning depth level and a same vertical coordinate, that is, a node at a same partitioning depth and a same coordinate as the current node. Then, it is determined that a distance between the current node and the node is a “short distance” or a “long distance”. In addition, when the node is a plane, a planar position of the node is referred to.

In this case, the target context information that is finally used for planar position information may be as follows:
(a) planar position information of the current node that is obtained through prediction by using occupancy information of the neighboring node, which includes three elements, that is, being predicted as a low plane, being predicted as a high plane, and being unpredictable;
(b) the spatial distance between the current node and the node at the same partitioning depth and the same coordinate as the current node, which is a “short distance” or a “long distance”;
(c) if the node at the same partitioning depth and the same coordinate as the current node is a plane, the planar position of the node is determined;
(d) coordinate dimensions of the current node (i=0, 1, 2);
(e) Ctx1, which, for example, is calculated by using planar structure information of a prediction node and three coplanar neighboring nodes that are respectively on the left of the prediction node, in front of the prediction node, and below the prediction node; and
(f) Ctx2, which, for example, is calculated by using planar structure information of three coplanar neighboring nodes that are respectively on the right of the prediction node, behind the prediction node, and above the prediction node.

That is, in this embodiment of this application, planar structure information of a prediction node and six coplanar neighboring nodes may be determined by using occupancy information of coplanar neighboring nodes shown in FIG. 12. Then, a context Ctx1 and a context Ctx2 of planar position information of a current node are calculated by using the planar structure information of the seven nodes. Finally, the planar position information of the current node is encoded by using Ctx1, Ctx2, and existing reference context information.

Some embodiments of this application further provide a bitstream, where the bitstream is generated by performing bit encoding according to to-be-encoded information, and the to-be-encoded information includes at least planar position information of a current node.

In this case, at an encoding end, the planar position information of the current node is written into the bitstream by using target context information. Subsequently, at a decoding end, first, the target context information is determined, and then the target context information may be used to decode the planar position information of the current node. In addition, it should be further noted that, when the target context information is a target context index value, to accelerate decoding, the target context index value may be written into a bitstream at the encoding end. Subsequently, at the decoding end, the target context index value may be directly obtained by decoding, a context model is determined based on the target context index value, and then the context model is used to decode the planar position information of the current node, thereby improving decoding efficiency.

An embodiment of this application provides an encoding method. Planar structure information of a preset node of a current node is determined based on a prediction node that is in a prediction frame and corresponds to the current node, where the preset node includes the prediction node and at least one target node in the prediction frame; context indication information of the current node is determined based on the planar structure information of the preset node; target context information is determined based on the context indication information; and planar position information of the current node is determined, the planar position information of the current node is encoded based on the target context information, and an encoded bit is written into a bitstream. In this way, in a process of encoding the planar position information of the current node by using the target context information, correlation between planar structure information of corresponding nodes in adjacent prediction frames is considered, and time domain correlation between the adjacent prediction frames is used to remove redundancy of planar structure information between the adjacent frames, thereby improving coding efficiency of geometric information of a point cloud, and improving encoding and decoding performance of the point cloud.

In another embodiment of this application, based on the decoding method or the encoding method in the foregoing embodiments, if a plane coding mode is used for a current node, target context information may be used to perform predictive encoding and decoding on planar position information of the current node. In this case, for the current node, first, whether the current node meets a plane coding condition needs to be determined.

In a G-PCC standard, whether a node meets a plane coding condition is determined. When the node meets the plane coding condition, predictive encoding is performed on plane mode information and planar position information of the node.

In this embodiment of this application, there are three conditions for determining whether a node meets a plane coding condition. The following describes the conditions in detail one by one.

1. Determine whether a node meets a plane coding condition based on a plane probability of the node in each dimension.

(1) Determine a local node density (local_node_density) of the current node.

(2) Determine a probability Prob(i) of the current node in each dimension.

When the local node density of the node is less than a threshold value Th (for example, Th=3), a plane probability Pro (i) of the current node in each of three coordinate dimensions is compared against a threshold Th0, Th1, or Th2, where Th0<Th1<Th2 (for example, Th0=0.6, Th1=0.77, and Th2=0.88). Herein, Eligible; (i=0,1,2) may be used to indicate whether to enable plane coding in a respective dimension: Eligibleᵢ=Prob(i)≥threshold.

It should be noted that the threshold changes adaptively. For example, when Prob(0)>Prob(1)>Prob(2), Eligible; is set as follows:

$${Eligible}_{0} = Prob ( 0 ) \geq Th 0 ;$$

$${Eligible}_{1} = Prob ( 1 ) \geq Th 1 ;$$

$${Eligible}_{2} = Prob ( 2 ) \geq Th 2.$$

When Prob(1)>Prob(0)>Prob(2), Eligible; is set as follows:

$${Eligible}_{0} = Prob ( 0 ) \geq Th 1 ;$$

$${Eligible}_{1} = Prob ( 1 ) \geq Th 0 ;$$

$${Eligible}_{2} = Prob ( 2 ) \geq Th 2.$$

Herein, Prob(i) is updated specifically as follows:

$${Prob ( i )}_{new} = ( L \times Prob ( i ) + δ ( coded node ) ) / L + 1 \qquad ( 7 )$$

Herein, L=255. In addition, if a coded node is a plane, 8 (coded node) is 1. Otherwise, 8 (coded node) is 0.

Herein, local_node_density is updated specifically as follows:

$$local\_node {\_density}_{new} = local\_node \_density + 4 * numSiblings \qquad ( 8 )$$

Herein, local_node_density is initialized to 4, and numSiblings is a quantity of sibling nodes of the node. Exemplarily, FIG. 16 is a schematic diagram of sibling nodes of a current node according to an embodiment of this application. As shown in FIG. 16, if the current node is a node filled with slanting lines, and nodes filled with grids are sibling nodes, a quantity of the sibling nodes of the current node is 5 (including the current node).

2. Determine, based on a point cloud density of a current layer, whether a node at the current layer meets a plane coding condition.

A point density of the current layer is used to determine whether to perform plane coding on the node at the current layer. A quantity of points in a currently to-be-encoded point cloud is represented as pointCount, and a quantity of points that have been reconstructed through IDCM coding is represented as numPointCountRecon. In addition, because octree coding is performed based on a breadth-first traversal sequence, a quantity of to-be-encoded nodes at the current layer may be obtained, which is represented as nodeCount. In this case, whether plane coding is enabled for the current layer is represented as planarEligibleKOctreeDepth, which is determined specifically as, planarEligibleKOctreeDepth=(pointCount-numPointCountRecon)<nodeCount×1.3.

If (pointCount-numPointCountRecon) is less than nodeCount×1.3, planarEligibleKOctreeDepth is true, or if (pointCount-numPointCountRecon) is not less than nodeCount×1.3, planarEligibleKOctreeDepth is false. In this way, when planarEligibleKOctreeDepth is true, plane coding is performed on all nodes at the current layer. Otherwise, plane coding is not performed on any node at the current layer, and only octree coding is used.

3. Determine, based on a collection parameter of a LiDAR point cloud, whether a current node meets a plane coding condition.

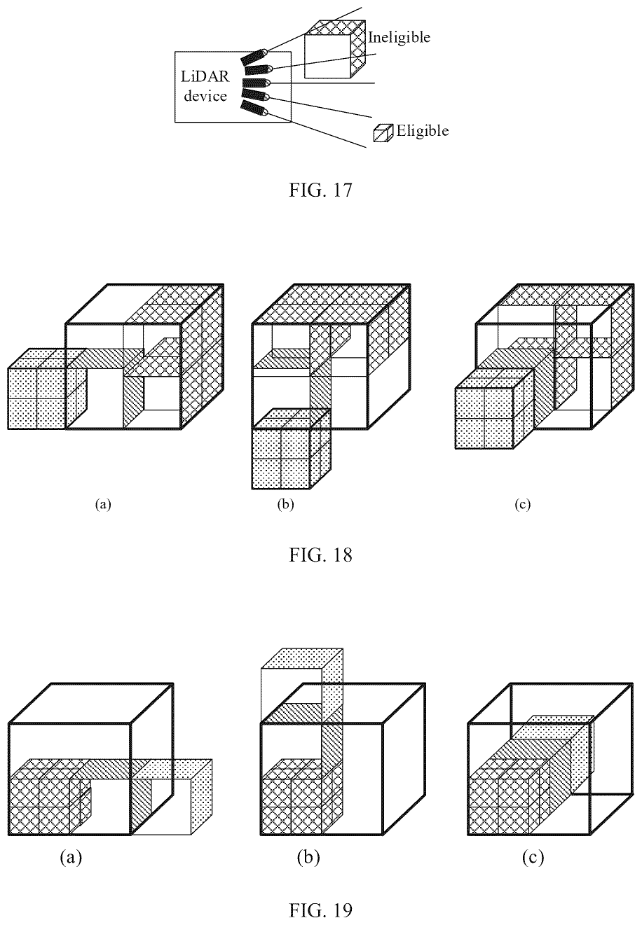

FIG. 17 is a schematic diagram of intersection between a LiDAR device and a node according to an embodiment of this application. As shown in FIG. 17, a grid-filled node is simultaneously passed through by rays of two lasers (Laser). Therefore, a current node is not a plane in a vertical Z-axis direction. A node filled with slanting lines is so small that the node cannot be simultaneously passed through by two lasers. Therefore, the green node may be a plane in the vertical Z-axis direction.

Further, for a node that meets a plane coding condition, predictive encoding may be performed on planar mode information and planar position information.

First, predictive encoding is performed on the planar mode information.

Herein, only three pieces of context information are used for encoding, that is, context is designed separately for a plane mode in each coordinate dimension.

Second, predictive encoding is performed on the planar position information.

It should be understood that, for encoding of planar position information of a non-LiDAR point cloud, in a related technology, existing reference context information may include:
(a) planar position information of the current node that is obtained through prediction by using occupancy information of the neighboring node, which includes three elements, that is, being predicted as a low plane, being predicted as a high plane, and being unpredictable;
(b) the spatial distance between the current node and the node at the same partitioning depth and the same coordinate as the current node, which is “short” or “long”;
(c) if the node at the same partitioning depth and the same coordinate as the current node is a plane, a planar position of the node is determined; and
(d) coordinate dimensions (i=0, 1, 2).

Exemplarily, FIG. 14 is used as an example. The current node is a grid-filled small cube, and a neighboring node is searched for at a same octree partitioning depth level and a same vertical coordinate. The neighboring node is a small cube filled with the white color. It is determined that a distance between the two nodes is “short” or “long”, and the planar position of the node is referred to.

FIG. 18 is a schematic diagram showing that a current node is located on a low plane of a parent node according to an embodiment of this application. As shown in FIG. 18, (a), (b), and (c) show examples of three cases in which the current node is located on a low plane of the parent node. Detailed descriptions are as follows.

(1) If any one of child nodes 4 to 7 of a point-filled node is occupied, and none of grid-filled nodes is occupied, it is very likely that a plane exists in the current node (filled with slanting lines), and a position of the plane is relatively low.

(2) If none of child nodes 4 to 7 of a point-filled node is occupied, and all grid-filled nodes are occupied, it is very likely that a plane exists in the current node (filled with slanting lines), and a position of the plane is relatively high.

(3) If all child nodes 4 to 7 of a point-filled node are empty nodes, and all grid-filled nodes are empty nodes, a position of the plane cannot be inferred and therefore is marked as unknown.

(4) If any one of child nodes 4 to 7 of a point-filled node is occupied, and any one of grid-filled nodes is occupied, a position of the plane cannot be inferred and therefore is marked as unknown.

FIG. 19 is a schematic diagram showing that a current node is located on a high plane of a parent node according to an embodiment of this application. As shown in FIG. 19, (a), (b), and (c) show examples of three cases in which the current node is located on a high plane of the parent node. Detailed descriptions are as follows.

(1) If any one of child nodes 4 to 7 of a grid-filled node is occupied, and a point-filled node is not occupied, it is very likely that a plane exists in the current node (filled with slanting lines), and a position of the plane is relatively low.

(2) If none of child nodes 4 to 7 of a grid-filled node is not occupied, and a point-filled node is occupied, it is very likely that a plane exists in the current node (filled with slanting lines), and a position of the plane is relatively high.

(3) If none of child nodes 4 to 7 of a grid-filled node is not occupied, and a point-filled node is not occupied, a position of the plane cannot be inferred and therefore is marked as unknown.

(4) If one of child nodes 4 to 7 of a grid-filled node is occupied, and a point-filled node is occupied, a position of the plane cannot be inferred and therefore is marked as unknown.

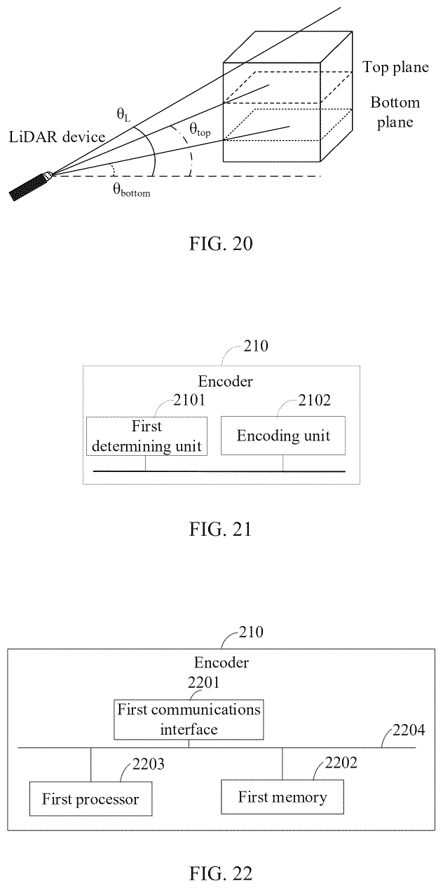

It should be further understood that, for encoding of planar position information of a LiDAR point cloud, FIG. 20 is a schematic diagram of predictive encoding of planar position information of a LiDAR point cloud according to an embodiment of this application. As shown in FIG. 20, a case in which an emission angle of a LiDAR device is θ_{bottom} may be mapped to a bottom plane (Bottom virtual plane), or a case in which the emission angle of the LiDAR device is θₜₒₚ may be mapped to a top plane (Top virtual plane).

That is, a planar position of a current node is predicted by using a collection parameter of the LiDAR device. Then, the position is quantized into a plurality of intervals by using a position at which the current node intersects a laser ray, and finally serves as context information of the planar position of the current node. A specific calculation process is as follows. Assuming that coordinates of the LiDAR device are (x_{Lidar},y_{Lidar},z_{Lidar}) and geometric coordinates of the current node are (x, y, z), first, a vertical tangent value tan θ of the current node relative to the LiDAR device is calculated by using the following formula:

$$tan θ = \frac{z - {z}_{Lidar}}{\sqrt{{( x - {x}_{Lidar} )}^{2} + {( y - {y}_{Lidar} )}^{2}}} \qquad ( 9 )$$

Further, because each laser has a deflection angle relative to the LiDAR device, a relative tangent value tan θ_{corr,L} of the current node relative to the laser further is calculated by using the following formula:

$$tan {θ}_{corr , L} = \frac{z - {z}_{Lidar} - {z}_{L}}{\sqrt{{( x - {x}_{Lidar} )}^{2} + {( y - {y}_{Lidar} )}^{2}}} = tan θ - \frac{{z}_{L}}{r} \qquad ( 10 )$$

Finally, the relative tangent value tan θ_{corr,L} of the current node is used to predict the planar position of the current node. Specifically, it is assumed that a tangent value of a lower boundary of the current node is tan (@bottom), and a tangent value of an upper boundary of the current node is tan (θₜₒₚ). The planar position is quantized into four quantization intervals according to tan θ_{corr,L}, that is, context information of the planar position is determined.

In this way, when it is determined that the current node meets a plane coding condition, not only predictive encoding and decoding is performed on planar position information of the current node by using some prior reference information in a related technology, but also time domain correlation of nodes between adjacent frames may be considered. Specifically, predictive encoding may be performed on the planar position information of the current node by considering planar structure information of a prediction node in a prediction frame, thereby improving plane coding efficiency of the current node.

In this embodiment of this application, this technical solution may be implemented at both an encoding end and a decoding end. When planar information is encoded, predictive encoding is performed on planar position information of a current node by using occupancy information of a neighboring node. Details are as follows.

For an octree algorithm at an encoding end, first, conditional enabling of plane coding may be optimized. Specifically, it may be seen from FIG. 11 that the node c is the prediction node that is in the prediction frame and corresponds to the current node (that is, the node a) in the current frame. First, whether the prediction node belongs to a real plane is determined by using the occupancy information of the prediction node. Assuming that the planar mode information of the prediction node is PredPlanMode, it is determined, by using the planar mode information of the prediction node, whether plane coding is enabled for the current node in three dimensional directions, that is, Eligibleᵢ (i=0, 1, 2).

Next, encoding of the planar position information may be optimized. Specifically, it may be seen from FIG. 12 that a node represented by a bold solid line is the prediction node, and nodes represented by dash-dotted lines are six neighboring nodes that are coplanar with the prediction node. Geometric information of the prediction node may be obtained at both an encoding end and a decoding end. Herein, occupancy information of the six neighboring nodes that are coplanar with the prediction node may be known. Predictive encoding is performed on the planar position information of the current node by using the occupancy information of the prediction node and the six neighboring nodes that are coplanar with the prediction node.

Exemplarily, predictive encoding of planar position information in an X-axis direction is used as an example. It is assumed that contexts used for the planar position information of the current node are respectively Ctx1 and Ctx2, and corresponding calculation manners are as follows.

Ctx1: designed by using planar structure information of the six coplanar neighboring nodes. It is assumed that the occupancy information of the six coplanar neighboring nodes is respectively coPlanarLeft, coPlanarRight, coPlanarFront, coPlanarBelow, coPlanarUpper, and coPlanarDown. First, occupancy information of three coplanar neighboring nodes is used to calculate planar structure information of the three nodes, including planar mode (planarMode) information and planar position (PlanePos) information. Herein, the occupancy information of the three coplanar neighboring nodes and the occupancy information of the prediction node are used to calculate planar structure information of each node, represented as PredNodePlaneMode, PredNodePlanePos, coPlanarLeftPlaneMode, coPlanarLeftPlanePos, coPlanarFrontPlaneMode, coPlanarFrontPlanePos, coPlanarDownPlaneMode, and coPlanarDown PlanePos. Then, Ctx1 is calculated by using planar structure information of the prediction node and three coplanar neighboring nodes that are respectively on the left of the prediction node, in front of the prediction node, and below the prediction node. For details, refer to the formula (3).

Ctx2: It is assumed that occupancy information of three coplanar neighboring nodes that are respectively on the right of the prediction node, behind the prediction node, and above the prediction node is respectively coEdgerRight, coEdgerUpper, and coEdgerBelow. First, the occupancy information of these coplanar neighboring nodes is used to calculate planar structure information corresponding to each node, represented as coPlanarRightPlaneMode, coPlanarRightPlanePos, coPlanarUpperPlaneMode, coPlanarUpperPlanePos, coPlanarBelowPlaneMode, and coPlanarBelow PlanePos. Then, Ctx2 is calculated by using the planar structure information corresponding to these coplanar neighboring nodes. For details, refer to the formula (4).

In this way, the final target context information of a planar position is as follows:
(a) planar position information of the current node that is obtained through prediction by using occupancy information of the neighboring node, which includes three elements, that is, being predicted as a low plane, being predicted as a high plane, and being unpredictable;
(b) the spatial distance between the current node and the node at the same partitioning depth and the same coordinate as the current node, which is a “short distance” or a “long distance”;
(c) if the node at the same partitioning depth and the same coordinate as the current node is a plane, the planar position of the node is determined;
(d) coordinate dimensions of the current node (i=0, 1, 2);
(e) Ctx1, which is calculated by using planar structure information of a prediction node and three coplanar neighboring nodes that are respectively on the left of the prediction node, in front of the prediction node, and below the prediction node; and
(f) Ctx2, which is calculated by using planar structure information of three coplanar neighboring nodes that are respectively on the right of the prediction node, behind the prediction node, and above the prediction node.

For an octree algorithm at a decoding end, similar to the algorithm at the encoding end, the contexts Ctx1 and Ctx2 of the planar position information of the current node may be obtained by using the occupancy information of the coplanar neighboring nodes shown in FIG. 12. Finally, the planar position information of the current node is decoded by using Ctx1, Ctx2, and existing reference context information.

Further, in embodiments of this application, Ctx1 is calculated by using planar position information and planar mode information of the prediction node and three coplanar neighboring nodes that are respectively on the left of the prediction node, in front of the prediction node, and below the prediction node, and Ctx2 is calculated by using planar position information and planar mode information of three coplanar neighboring nodes that are respectively on the right of the prediction node, behind the prediction node, and above the prediction node. Alternatively, calculation of Ctx1 includes only the planar position information of the seven nodes, and calculation of Ctx2 includes only the planar mode information of the seven nodes. For details, refer to the formula (5) and the formula (6).

Further, in embodiments of this application, calculation of Ctx1 and Ctx2 may not be limited. Herein, although only two manners of calculating Ctx1 and Ctx2 by using planar structure information of neighboring nodes are provided, this is not specifically limited. What is protected in embodiments of this application is that Ctx1 and Ctx2 are inferred by using occupancy information of neighboring nodes, and how to perform the calculation is not specifically limited.

Further, in embodiments of this application, a reference range of neighboring nodes may not be limited. In consideration of a balance between coding efficiency, time complexity, memory usage, and the like, only the occupancy information of the six neighboring nodes and the one prediction node is considered herein, but a reference range of neighboring nodes is not limited herein. For example, only a coplanar neighboring node, or a coplanar neighboring node and a co-edge neighboring node, or a larger reference range of neighboring nodes may be referred to. No specific limitation is imposed herein.

Further, in embodiments of this application, reference information finally obtained by using the occupancy information of the neighboring nodes and a context finally used for a planar position are not limited. The planar structure information of the neighboring nodes that are coplanar, co-edge, or co-vertex with the prediction node may be used to perform a simple AND/OR operation, to obtain Ctx1 and Ctx2 through direct calculation. Finally, Ctx1 and Ctx2 are used to determine a context of planar position coding. In embodiments of this application, a context that is finally used for encoding is not limited. For example, Ctx1 and Ctx2 may be mapped, in some manners such as spatial rotation invariance or context mapping, to obtain a new context. This is not limited.

Further, in embodiments of this application, a condition for enabling plane coding of a current node may be modified by using planar structure information of a prediction node. The planar structure information of the prediction node may be used to directly determine whether to perform plane coding on the current node to be encoded. In some embodiments of this application, the planar structure information of the prediction node and reference information of the current node may be used to determine whether to perform plane coding on the current node. Herein, how to use the planar structure information of the prediction node to determine the plane coding condition of the current node is not limited.

Briefly, in embodiments of this application, first, planar structure information of a prediction node is calculated by using occupancy information of the prediction node that is in a prediction frame and corresponds to a current node, and a condition for enabling plane coding of the current node is determined by using the planar structure information of the prediction node. Then, predictive encoding is performed on planar position information of the current node by considering planar structure information of adjacent prediction frames, thereby improving geometry coding efficiency of a point cloud. In addition, time domain correlation between adjacent frames is used to remove redundancy of planar structure information between the adjacent frames, thereby further improving coding efficiency of geometric information of the point cloud.

The following uses a lossless test environment under lossless geometric attributes as an example, where bpp is a performance indicator for measuring compression efficiency. When bpp is less than 100%, it indicates that coding efficiency is improved compared with an existing coding scheme. Details are shown in Table 1.

TABLE 1

| Test sequence (Sequences) | Test result (Geometry_bpp) |
|---|---|
| egyptian_mask_vox12 | 97.124% |
| facade_00009_vox12 | 96.340% |
| facade_00015_vox14 | 96.740% |
| frog_00067_vox12 | 95.015% |
| house_without_roof_00057_vox12 | 96.777% |
| shiva_00035_vox12 | 97.763% |
| ulb_unicorn_vox13 | 99.722% |
| arco_valentino_dense_vox12 | 99.866% |
| arco_valentino_dense_vox20 | 99.941% |
| egyptian_mask_vox20 | 99.071% |
| facade_00009_vox20 | 99.154% |
| facade_00015_vox20 | 98.989% |
| facade_00064_vox14 | 96.055% |
| facade_00064_vox20 | 99.070% |
| frog_00067_vox20 | 98.862% |
| head_00039_vox20 | 99.230% |
| house_without_roof_00057_vox20 | 98.800% |
| landscape_00014_vox20 | 98.710% |
| palazzo_carignano_dense_vox14 | 99.879% |
| palazzo_carignano_dense_vox20 | 99.947% |
| shiva_00035_vox20 | 99.345% |
| stanford_area_2_vox16 | 99.590% |
| stanford_area_2_vox20 | 99.610% |
| staue_klimt_vox12 | 95.984% |
| staue_klimt_vox20 | 98.876% |
| ulb_unicorn_hires_vox15 | 98.008% |
| ulb_unicorn_hires_vox20 | 99.327% |
| ulb_unicorn_vox20 | 99.907% |
| citytunnel_q1mm | 99.066% |
| overpass_q1mm | 98.886% |
| tollbooth_q1mm | 98.665% |

After tests, it may be seen from Table 1 that a single test sequence in the selected test sequence set may have a compression performance improved by up to 5% (frog_00067_vox12). Exemplarily, Table 2 shows a performance result under lossless geometry and lossless attributes (lossless geometry, lossless attributes), and Table 3 shows a performance result under lossy geometry and lossy attributes (lossy geometry, lossy attributes).

TABLE 2

| | Lossless geometry, lossless attributes [all intra] | | | |
|---|---|---|---|---|
| | bpip ratio[%] | | | |
| CW_ai | Geometry | Colour | Reflectance | Total |
| Cat1-A average | 97.9% | 100.0% | | 99.3% |
| Cat1-B average | 99.2% | 100.0% | | 99.5% |
| Cat3-fused average | 98.9% | 100.0% | 100.0% | 99.4% |
| Cat3-frame average | 100.0% | | 100.0% | 100.0% |
| Overall average | 99.1% | 100.0% | 100.0% | 99.5% |

| | |
|---|---|
| Avg. Enc. Time[%] | #NUM! |
| Avg. Dec. Time[%] | #NUM! |

TABLE 3

| | Lossy geometry, lossy attributes [all intra] | | | | | |
|---|---|---|---|---|---|---|
| | End-to-End BD-AttrRate[%] | | | | | |
| | | Chroma | Chroma | | Geom_BD-TotGeomRate[%] | |
| C2_ai | Luma | Cb | Cr | Reflectance | D1 | D2 |
| Cat1-A average | 0.0% | 0.0% | 0.0% | | −0.2% | −0.2% |
| Cat1-B average | 0.0% | 0.0% | 0.0% | | −1.0% | −1.0% |
| Cat3-fused | 0.0% | 0.0% | 0.0% | 0.0% | −1.3% | −1.3% |
| average | | | | | | |
| Cat3-frame | | | | 0.0% | 0.0% | 0.0% |
| average | | | | | | |
| Overall average | 0.0% | 0.0% | 0.0% | 0.0% | −0.5% | −0.5% |

| | |
|---|---|
| Avg. Enc. Time[%] | #NUM! |
| Avg. Dec. Time[%] | #NUM! |

In addition, plane coding is enabled for all test sequences, and test performance of existing TMC13-v19 is shown in Table 4.

TABLE 4

| | Lossless geometry, lossless attributes [all intra] | | | |
|---|---|---|---|---|
| | bpip ratio[%] | | | |
| CW_ai | Geometry | Colour | Reflectance | Total |
| Cat1-A average | 95.0% | 100.0% | | 98.5% |
| Cat1-B average | 99.2% | 100.0% | | 99.5% |
| Cat3-fused average | 98.9% | 100.0% | 100.0% | 99.4% |
| Cat3-frame average | 100.0% | | 100.0% | 100.0% |
| Overall average | 98.8% | 100.0% | 100.0% | 99.3% |

| | |
|---|---|
| Avg. Enc. Time[%] | #NUM! |
| Avg. Dec. Time[%] | #NUM! |

In embodiments of this application, specific implementations of the foregoing embodiment are described in detail by using the foregoing embodiments. It may be seen that, according to the technical solutions in the foregoing embodiments, during encoding or decoding of planar position information of a node, predictive encoding and decoding is performed on the planar position information of the current node by considering planar structure information of a node in a prediction frame, and coding efficiency of geometric information of a cloud point may be effectively improved by considering correlation between planar structure information of corresponding nodes in adjacent frames. In addition, in the technical solutions according to embodiments of this application, planar position information of the current node is predicted by using the planar structure information of the prediction node and planar structure information of six coplanar neighboring nodes that are coplanar with the prediction node. Similarly, planar structure information of more neighboring nodes may be considered, which is not limited herein. Therefore, coding efficiency of geometric information of the point cloud is further improved, and encoding and decoding performance of the point cloud is further enhanced.

In another embodiment of this application, based on a same invention concept as the foregoing embodiments, FIG. 21 is a schematic structural diagram of an encoder according to this embodiment of this application. As shown in FIG. 21, the encoder 210 may include a first determining unit 2101 and an encoding unit 2102, where
the first determining unit 2101 is configured to: determine, based on a prediction node that is in a prediction frame and corresponds to a current node, planar structure information of a preset node of the current node, where the preset node includes the prediction node and at least one target node in the prediction frame; determine, based on the planar structure information of the preset node, context indication information of the current node; determine, based on the context indication information, target context information; and determine planar position information of the current node; and
the encoding unit 2102 is configured to encode the planar position information of the current node based on the target context information, and write an encoded bit into a bitstream.

In some embodiments, the first determining unit 2101 is further configured to: when the current node meets a plane coding condition, determine that the planar position information of the current node is one of the following: low planar position information or high planar position information.

In some embodiments, the prediction frame is an encoded frame, and the prediction frame is adjacent to a current frame that includes the current node.

In some embodiments, the first determining unit 2101 is further configured to: determine the occupancy information of the prediction node; determine, based on the occupancy information of the prediction node, the planar mode information of the prediction node; and determine, based on the planar mode information of the prediction node, whether the plane coding mode is enabled for the current node in a preset direction.

In some embodiments, the first determining unit 2101 is further configured to: determine a neighboring node of the prediction node; and determine, based on the neighboring node of the prediction node, the at least one target node in the prediction frame, where the at least one target node includes at least one of the following: at least one coplanar node that shares a face with the prediction node, at least one co-edge node that shares an edge with the prediction node, or at least one co-vertex node that shares a vertex with the prediction node.

In some embodiments, the first determining unit 2101 is further configured to: determine neighboring nodes of the current node; determine, based on the prediction frame, respective prediction nodes of the neighboring nodes of the current node; and determine, based on the respective prediction nodes of the neighboring nodes of the current node, the at least one target node in the prediction frame, where the at least one target node includes at least one of the following: a prediction node corresponding to at least one coplanar node that shares a face with the current node, a prediction node corresponding to at least one co-edge node that shares an edge with the current node, or a prediction node corresponding to at least one co-vertex node that shares a vertex with the current node.

In some embodiments, the first determining unit 2101 is further configured to: determine, based on the planar structure information of the preset node, planar structure information of a first type preset node and planar structure information of a second type preset node; determine, based on the planar structure information of the first type preset node, first context indication information of the current node; and determine, based on the planar structure information of the second type preset node, second context indication information of the current node.

In some embodiments, when the first type preset node includes the prediction node and the first target node, the first determining unit 2101 is further configured to: determine occupancy information of the prediction node and occupancy information of the first target node; determine, based on the occupancy information of the prediction node, planar mode information of the prediction node and planar position information of the prediction node; determine, based on the occupancy information of the first target node, planar mode information of the first target node and planar position information of the first target node; form the planar structure information of the first type preset node according to the planar mode information of the prediction node, the planar position information of the prediction node, the planar mode information of the first target node, and the planar position information of the first target node; and determine, based on the planar mode information of the prediction node, the planar position information of the prediction node, the planar mode information of the first target node, and the planar position information of the first target node, the first context indication information of the current node.

In some embodiments, when the second type preset node includes a second target node, the first determining unit 2101 is further configured to: determine occupancy information of the second target node; determine, based on the occupancy information of the second target node, planar mode information of the second target node and planar position information of the second target node; form the planar structure information of the second type preset node according to the planar mode information of the second target node and the planar position information of the second target node; and determine, based on the planar mode information of the second target node and the planar position information of the second target node, the second context indication information of the current node.

In some embodiments, the first target node includes a coplanar node located on the left of the prediction node, a coplanar node located in front of the prediction node, and a coplanar node located below the prediction node; and the second target node includes a coplanar node located on the right of the prediction node, a coplanar node located behind the prediction node, and a coplanar node located above the prediction node; or,
the first target node includes a prediction node corresponding to a coplanar node located on the left of the current node, a prediction node corresponding to a coplanar node located in front of the current node, and a prediction node corresponding to a coplanar node located below the current node; and the second target node includes a prediction node corresponding to a coplanar node located on the right of the current node, a prediction node corresponding to a coplanar node located behind the current node, and a prediction node corresponding to a coplanar node located above the current node.

In some embodiments, the first determining unit 2101 is further configured to: determine, based on the planar structure information of the preset node, a first type planar structure information of the preset node and a second type planar structure information of the preset node; determine, based on the first type planar structure information of the preset node, first context indication information of the current node; and determine, based on the second type planar structure information of the preset node, second context indication information of the current node.

In some embodiments, when the preset node includes the prediction node and a third target node, the first determining unit 2101 is further configured to: determine occupancy information of the prediction node and occupancy information of the third target node; determine, based on the occupancy information of the prediction node and the occupancy information of the third target node, planar position information of the prediction node and planar position information of the third target node; form the first type planar structure information of the preset node according to the planar position information of the prediction node and the planar position information of the third target node; and determine, based on the planar position information of the prediction node and the planar position information of the third target node, the first context indication information of the current node.

In some embodiments, when the preset node includes the prediction node and a third target node, the first determining unit 2101 is further configured to: determine occupancy information of the prediction node and occupancy information of the third target node; determine, based on the occupancy information of the prediction node and the occupancy information of the third target node, planar mode information of the prediction node and planar mode information of the third target node; form the second type planar structure information of the preset node according to the planar mode information of the prediction node and the planar mode information of the third target node; and determine, based on the planar mode information of the prediction node and the planar mode information of the third target node, the second context indication information of the current node.

In some embodiments, the third target node includes a coplanar node located on the left of the prediction node, a coplanar node located in front of the prediction node, a coplanar node located below the prediction node, a coplanar node located on the right of the prediction node, a coplanar node located behind the prediction node, and a coplanar node located above the prediction node; or, the third target node includes a prediction node corresponding to a coplanar node located on the left of the current node, a prediction node corresponding to a coplanar node located in front of the current node, a prediction node corresponding to a coplanar node located below the current node, a prediction node corresponding to a coplanar node located on the right of the current node, a prediction node corresponding to a coplanar node located behind the current node, and a prediction node corresponding to a coplanar node located above the current node.

In some embodiments, the first determining unit 2101 is further configured to: acquire the first context indication information of the current node and the second context indication information of the current node; and determine, based on the first context indication information and the second context indication information, the target context information.

In some embodiments, the first determining unit 2101 is further configured to: perform context mapping processing according to the first context indication information and the second context indication information, to obtain new context information; and determine, based on the new context information, the target context information.

In some embodiments, the first determining unit 2101 is further configured to: determine reference context information of the current node; and determine, based on the first context indication information, the second context indication information, and the reference context information, the target context information.

In some embodiments, that the first determining unit 2101 is further configured to determine the reference context information of the current node includes at least one of the following:
performing prediction, based on occupancy information of the neighboring node, to determine a predicted value of the planar position information of the current node, where the predicted value includes one of the following: being a low plane, being a high plane, or being unpredictable;
determining a spatial distance between the current node and a node at a same partitioning depth and a same coordinate as the current node, where the spatial distance meets one of the following: a short distance or a long distance;
determining whether the node at the same partitioning depth and the same coordinate as the current node is a plane, and if the node is a plane, determining a planar position of the node; or
determining coordinate dimension information of the current node.

In some embodiments, the first determining unit 2101 is further configured to: determine occupancy information of the prediction node; determine, based on the occupancy information of the prediction node, planar structure information of the prediction node; and determine, based on the planar structure information of the prediction node, whether a plane coding mode is enabled for the current node in a preset direction.

In some embodiments, the first determining unit 2101 is further configured to: acquire reference information of the current node; and determine, based on the planar structure information of the prediction node and the reference information of the current node, whether the plane coding mode is enabled for the current node in the preset direction.

It may be understood that, in embodiments of this application, the term “unit” may be a partial circuit, a partial processor, a partial program or software, or the like. Certainly, the term “unit” may be a module or may be in a non-modular form. In addition, various parts in embodiments may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in a form of a software functional module and not sold or used as an independent product, the integrated unit may be stored in a computer-readable storage medium. Based on such an understanding, the technical solutions of embodiments essentially, or the part contributing to the conventional technology, or all or some of the technical solutions may be implemented in a form of a software product. The computer software product is stored in a storage medium and includes several instructions for instructing a computer device (which may be a personal computer, a server, or a network device) or a processor (processor) to execute all or some of the steps of the methods described in the embodiments. The foregoing storage medium includes various media that may store a program code, such as a USB flash drive, a removable hard disk, a read-only memory (Read Only Memory, ROM), a random access memory (Random Access Memory, RAM), a magnetic disk, or an optical disc.

Therefore, an embodiment of this application provides a computer-readable storage medium, applied to the encoder 210. The computer-readable storage medium stores a computer program, and the computer program is executed by a first processor to implement the method in any one of the foregoing embodiments.

Based on the composition of the encoder 210 and the computer-readable storage medium, FIG. 22 is a schematic diagram of a structure of specific hardware of the encoder 210 according to an embodiment of this application. As shown in FIG. 22, the encoder 210 may include a first communications interface 2201, a first memory 2202, and a first processor 2203. The components are coupled together by using a first bus system 2204. It may be understood that the first bus system 2204 is configured to implement connection and communication between these components. In addition to a data bus, the first bus system 2204 further includes a power bus, a control bus, and a status signal bus. However, for clarity of description, various buses are all marked as the first bus system 2204 in FIG. 22.

The first communications interface 2201 is configured to receive and transmit signals in a process of transmitting and receiving information with other external network elements.

The first memory 2202 is configured to store a computer program that is runnable on the first processor 2203.

The first processor 2203 is configured to run the computer program to execute the following operations:
determining, based on a prediction node that is in a prediction frame and corresponds to a current node, planar structure information of a preset node of the current node, where the preset node includes the prediction node and at least one target node in the prediction frame;
determining, based on the planar structure information of the preset node, context indication information of the current node;
determining, based on the context indication information, target context information; and
determining planar position information of the current node, encoding, based on the target context information, the planar position information of the current node, and writing an encoded bit into a bitstream.

It may be understood that, in embodiments of this application, the first memory 2202 may be a volatile memory or a non-volatile memory, or may include both a volatile memory and a non-volatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a random access memory (Random Access Memory, RAM), and is used as an external cache. By way of example rather than limitative description, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDRSDRAM), an enhanced synchronous dynamic random access memory (Enhanced SDRAM, ESDRAM), a synchlink dynamic random access memory (Synchlink DRAM, SLDRAM), and a direct Rambus random access memory (Direct Rambus RAM, DRRAM). The first memory 2202 in the systems and the methods described in this application include but are not limited to these and any memory of another appropriate type.

However, the first processor 2203 may be an integrated circuit chip that has a signal processing capability. In an implementation process, the steps in the foregoing methods may be completed by using an integrated logic circuit of hardware in the first processor 2203 or an instruction in a form of software. The foregoing first processor 2203 may be a general-purpose processor, a digital signal processor (Digital Signal Processor, DSP), an application-specific integrated circuit (Application Specific Integrated Circuit, ASIC), a field-programmable gate array (Field Programmable Gate Array, FPGA) or another programmable logic device, a discrete gate or transistor logic device, or a discrete hardware component. The processor may implement or execute the methods, steps, and logical block diagrams disclosed in embodiments of this application. The general-purpose processor may be a microprocessor, or the processor may be any conventional processor or the like. The steps of the methods disclosed with reference to embodiments of this application may be directly executed by a hardware decoding processor, or executed by a combination of hardware and software modules in the decoding processor. The software module may be located in a mature storage medium in the art, for example, a random access memory, a flash memory, a read-only memory, a programmable read-only memory, an erasable programmable memory, or a register. The storage medium is located in the first memory 2202. The first processor 2203 reads information in the first memory 2202 and completes the steps of the foregoing methods in combination with hardware of the first processor 2203.

It may be understood that the embodiments described in this application may be implemented by hardware, software, firmware, middleware, microcode, or a combination thereof. For hardware implementation, the processing unit may be implemented in one or more application-specific integrated circuits (Application Specific Integrated Circuits, ASIC), digital signal processors (Digital Signal Processing, DSP), digital signal processing devices (DSP Device, DSPD), programmable logic devices (Programmable Logic Device, PLD), field-programmable gate arrays (Field-Programmable Gate Array, FPGA), general-purpose processors, controllers, microcontrollers, microprocessors, and other electronic units configured to execute the functions described in this application, or a combination thereof. For software implementation, the technology described in this application may be implemented by using a module (such as a process or a function) that executes the function described in this application. The software code may be stored in a memory and executed by a processor. The memory may be implemented in or outside the processor.

Optionally, in another embodiment, the first processor 2203 is further configured to: execute the encoding method in any one of the foregoing embodiments when running the computer program.

An embodiment of this application provides an encoder. For the encoder, in a process of encoding planar position information of a current node by using target context information, the target context information is determined by considering planar structure information of a prediction node in a prediction frame. In this way, correlation between planar structure information of corresponding nodes in adjacent prediction frames is considered, and time domain correlation between the adjacent prediction frames is used to remove redundancy of planar structure information between the adjacent frames, which may improve coding efficiency of geometric information of a point cloud, thereby improving encoding and decoding performance of the point cloud.

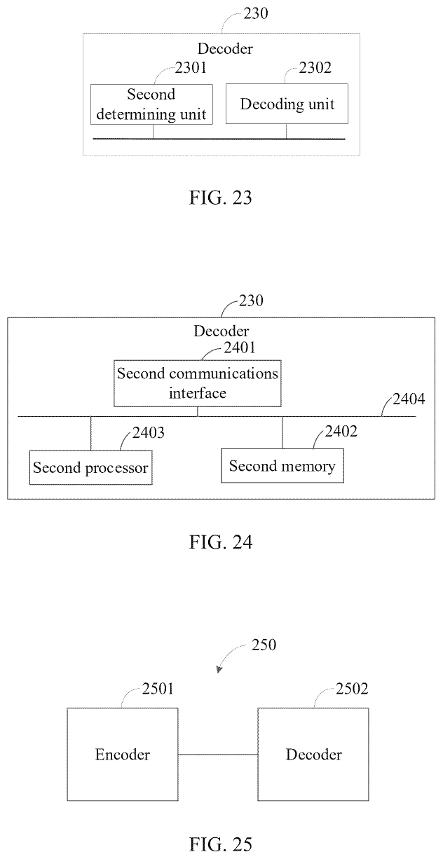

In another embodiment of this application, based on a same invention concept as the foregoing embodiments, FIG. 23 is a schematic structural diagram of a decoder according to this embodiment of this application. As shown in FIG. 23, the decoder 230 may include a second determining unit 2301 and a decoding unit 2302, where
the second determining unit 2301 is configured to: determine, based on a prediction node that is in a prediction frame and corresponds to a current node, planar structure information of a preset node of the current node, where the preset node includes the prediction node and at least one target node in the prediction frame; determine, based on the planar structure information of the preset node, context indication information of the current node; and determine, based on the context indication information, target context information; and
the decoding unit 2302 is configured to decode a bitstream based on the target context information, to determine planar position information of the current node.

In some embodiments, the prediction frame is a decoded frame, and the prediction frame is adjacent to a current frame that includes the current node.

In some embodiments, the second determining unit 2301 is further configured to: determine the occupancy information of the prediction node; determine, based on the occupancy information of the prediction node, the planar mode information of the prediction node; and determine, based on the planar mode information of the prediction node, whether the plane coding mode is enabled for the current node in a preset direction.

In some embodiments, the second determining unit 2301 is further configured to: determine a neighboring node of the prediction node; and determine, based on the neighboring node of the prediction node, the at least one target node in the prediction frame, where the at least one target node includes at least one of the following: at least one coplanar node that shares a face with the prediction node, at least one co-edge node that shares an edge with the prediction node, or at least one co-vertex node that shares a vertex with the prediction node.

In some embodiments, the second determining unit 2301 is further configured to: determine neighboring nodes of the current node; determine, based on the prediction frame, respective prediction nodes of the neighboring nodes of the current node; and determine, based on the respective prediction nodes of the neighboring nodes of the current node, the at least one target node in the prediction frame, where the at least one target node includes at least one of the following: a prediction node corresponding to at least one coplanar node that shares a face with the current node, a prediction node corresponding to at least one co-edge node that shares an edge with the current node, or a prediction node corresponding to at least one co-vertex node that shares a vertex with the current node.

In some embodiments, the second determining unit 2301 is further configured to: determine, based on the planar structure information of the preset node, planar structure information of a first type preset node and planar structure information of a second type preset node; determine, based on the planar structure information of the first type preset node, first context indication information of the current node; and determine, based on the planar structure information of the second type preset node, second context indication information of the current node.

In some embodiments, when the first type preset node includes the prediction node and the first target node, the second determining unit 2301 is further configured to: determine occupancy information of the prediction node and occupancy information of the first target node; determine, based on the occupancy information of the prediction node, planar mode information of the prediction node and planar position information of the prediction node; determine, based on the occupancy information of the first target node, planar mode information of the first target node and planar position information of the first target node; form the planar structure information of the first type preset node according to the planar mode information of the prediction node, the planar position information of the prediction node, the planar mode information of the first target node, and the planar position information of the first target node; and determine, based on the planar mode information of the prediction node, the planar position information of the prediction node, the planar mode information of the first target node, and the planar position information of the first target node, the first context indication information of the current node.

In some embodiments, when the second type preset node includes a second target node, the second determining unit 2301 is further configured to: determine occupancy information of the second target node; determine, based on the occupancy information of the second target node, planar mode information of the second target node and planar position information of the second target node; form the planar structure information of the second type preset node according to the planar mode information of the second target node and the planar position information of the second target node; and determine, based on the planar mode information of the second target node and the planar position information of the second target node, the second context indication information of the current node.

In some embodiments, the first target node includes a coplanar node located on the left of the prediction node, a coplanar node located in front of the prediction node, and a coplanar node located below the prediction node; and the second target node includes a coplanar node located on the right of the prediction node, a coplanar node located behind the prediction node, and a coplanar node located above the prediction node; or,
the first target node includes a prediction node corresponding to a coplanar node located on the left of the current node, a prediction node corresponding to a coplanar node located in front of the current node, and a prediction node corresponding to a coplanar node located below the current node; and the second target node includes a prediction node corresponding to a coplanar node located on the right of the current node, a prediction node corresponding to a coplanar node located behind the current node, and a prediction node corresponding to a coplanar node located above the current node.

In some embodiments, the second determining unit 2301 is further configured to: determine, based on the planar structure information of the preset node, a first type planar structure information of the preset node and a second type planar structure information of the preset node; determine, based on the first type planar structure information of the preset node, first context indication information of the current node; and determine, based on the second type planar structure information of the preset node, second context indication information of the current node.

In some embodiments, when the preset node includes the prediction node and a third target node, the second determining unit 2301 is further configured to: determine occupancy information of the prediction node and occupancy information of the third target node; determine, based on the occupancy information of the prediction node and the occupancy information of the third target node, planar position information of the prediction node and planar position information of the third target node; form the first type planar structure information of the preset node according to the planar position information of the prediction node and the planar position information of the third target node; and determine, based on the planar position information of the prediction node and the planar position information of the third target node, the first context indication information of the current node.

In some embodiments, when the preset node includes the prediction node and a third target node, the second determining unit 2301 is further configured to: determine occupancy information of the prediction node and occupancy information of the third target node; determine, based on the occupancy information of the prediction node and the occupancy information of the third target node, planar mode information of the prediction node and planar mode information of the third target node; form the second type planar structure information of the preset node according to the planar mode information of the prediction node and the planar mode information of the third target node; and determine, based on the planar mode information of the prediction node and the planar mode information of the third target node, the second context indication information of the current node.

In some embodiments, the third target node includes a coplanar node located on the left of the prediction node, a coplanar node located in front of the prediction node, a coplanar node located below the prediction node, a coplanar node located on the right of the prediction node, a coplanar node located behind the prediction node, and a coplanar node located above the prediction node; or, the third target node includes a prediction node corresponding to a coplanar node located on the left of the current node, a prediction node corresponding to a coplanar node located in front of the current node, a prediction node corresponding to a coplanar node located below the current node, a prediction node corresponding to a coplanar node located on the right of the current node, a prediction node corresponding to a coplanar node located behind the current node, and a prediction node corresponding to a coplanar node located above the current node.

In some embodiments, the second determining unit 2301 is further configured to: acquire the first context indication information of the current node and the second context indication information of the current node; and determine, based on the first context indication information and the second context indication information, the target context information.

In some embodiments, the second determining unit 2301 is further configured to: perform context mapping processing according to the first context indication information and the second context indication information, to obtain new context information; and determine, based on the new context information, the target context information.

In some embodiments, the second determining unit 2301 is further configured to: determine reference context information of the current node; and determine, based on the first context indication information, the second context indication information, and the reference context information, the target context information.

In some embodiments, that the second determining unit 2301 is further configured to determine the reference context information of the current node includes at least one of the following:
performing prediction, based on occupancy information of the neighboring node, to determine a predicted value of the planar position information of the current node, where the predicted value includes one of the following: being a low plane, being a high plane, or being unpredictable;
determining a spatial distance between the current node and a node at a same partitioning depth and a same coordinate as the current node, where the spatial distance includes one of the following: a short distance or a long distance;
determining whether the node at the same partitioning depth and the same coordinate as the current node is a plane, and if the node is a plane, determining a planar position of the node; or
determining coordinate dimension information of the current node.

In some embodiments, the second determining unit 2301 is further configured to: determine occupancy information of the prediction node; determine, based on the occupancy information of the prediction node, planar structure information of the prediction node; and determine, based on the planar structure information of the prediction node, whether a plane coding mode is enabled for the current node in a preset direction.

In some embodiments, the second determining unit 2301 is further configured to: acquire reference information of the current node; and determine, based on the planar structure information of the prediction node and the reference information of the current node, whether the plane coding mode is enabled for the current node in the preset direction.

It may be understood that in embodiments, the term “unit” may be a partial circuit, a partial processor, a partial program or software, or the like. Certainly, the term “unit” may be a module or may be in a non-modular form. In addition, various parts in embodiments may be integrated into one processing unit, or each of the units may exist alone physically, or two or more units may be integrated into one unit. The foregoing integrated unit may be implemented in a form of hardware, or may be implemented in a form of a software functional module.

When the integrated unit is implemented in the form of a software functional module and not sold or used as an independent product, the integrated unit may be stored in a computer-readable storage medium. Based on such an understanding, an embodiment provides a computer-readable storage medium, applied to the decoder 230. The computer-readable storage medium stores a computer program, and the computer program is executed by a second processor to implement the decoding method according to any one of the foregoing embodiments.

Based on the composition of the decoder 230 and the computer-readable storage medium, FIG. 24 is a schematic diagram of a structure of specific hardware of the decoder 230 according to an embodiment of this application. As shown in FIG. 24, the decoder 230 may include a second communications interface 2401, a second memory 2402, and a second processor 2403. The components are coupled together by using a second bus system 2404. It may be understood that the second bus system 2404 is configured to implement connection and communication between these components. In addition to a data bus, the second bus system 2404 further includes a power bus, a control bus, and a status signal bus. However, for clarity of description, various buses are all marked as the second bus system 2404 in FIG. 24.

The second communications interface 2401 is configured to receive and transmit a signal in a process of transmitting and receiving information between the second communications interface and another external network element.

The second memory 2402 is configured to store a computer program that is runnable on the second processor 2403.

The second processor 2403 is configured to run the computer program to execute the following operations:
determining, based on a prediction node that is in a prediction frame and corresponds to a current node, planar structure information of a preset node of the current node, where the preset node includes the prediction node and at least one target node in the prediction frame;
determining, based on the planar structure information of the preset node, context indication information of the current node;
determining, based on the context indication information, target context information; and
decoding a bitstream based on the target context information, to determine planar position information of the current node.

Optionally, in another embodiment, the second processor 2403 is further configured to run the computer program to execute the decoding method according to any one of the foregoing embodiments.

It may be understood that hardware functions of the second memory 2402 are similar to those of the first memory 2202, and hardware functions of the second processor 2403 are similar to those of the first processor 2203, which is not detailed here.

An embodiment of this application provides a decoder. For the decoder, in a process of decoding planar position information of a current node by using target context information, the target context information is determined by considering planar structure information of a prediction node in a prediction frame. In this way, correlation between planar structure information of corresponding nodes in adjacent prediction frames is considered, and time domain correlation between the adjacent prediction frames is used to remove redundancy of planar structure information between the adjacent frames, which may improve coding efficiency of geometric information of a point cloud, thereby improving encoding and decoding performance of the point cloud.

In another embodiment of this application, FIG. 25 is a schematic structural diagram of an encoding and decoding system according to this embodiment of this application. As shown in FIG. 25, the encoding and decoding system 250 may include an encoder 2501 and a decoder 2502.

In this embodiment of this application, the encoder 2501 may be the encoder according to any one of the foregoing embodiments, and the decoder 2502 may be the decoder according to any one of the foregoing embodiments.

It should be noted that in this application, the term “include”, “comprise” or any other variant is intended to cover non-exclusive inclusion, so that a process, a method, an object or an apparatus that includes a series of elements not only includes those elements, but also includes other elements that are not explicitly listed, or includes inherent elements of the process, method, object or apparatus. In the absence of further restrictions, the element limited by the sentence “including a . . . ” does not exclude the existence of other identical elements in the process, method, item or device including this element.

The foregoing sequence numbers of embodiments of this application are merely used for description, and do not represent preference between the embodiments.

The methods disclosed in the several method embodiments provided in this application may be randomly combined without conflict to obtain new method embodiments.

The features disclosed in the several product embodiments provided in this application may be randomly combined without conflict to obtain a new product embodiment.

The features disclosed in the several method embodiments or device embodiments provided in this application may be randomly combined without conflict to obtain a new method embodiment or device embodiment.

The foregoing descriptions are merely some specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

### Industrial Practicality

In embodiments of this application, no matter at an encoding end or a decoding end, planar structure information of a preset node of a current node is determined based on a prediction node that is in a prediction frame and corresponds to the current node, where the preset node includes the prediction node and at least one target node in the prediction frame; context indication information of the current node is determined based on the planar structure information of the preset node; and target context information is determined based on the context indication information. In this way, at the encoding end, after planar position information of the current node is determined, the planar position information of the current node is encoded based on the target context information, and an encoded bit is written into a bitstream. At the decoding end, the bitstream may be decoded based on the target context information, to determine the planar position information of the current node. That is, in a process of encoding and decoding the planar position information of the current node by using the target context information, the target context information is determined by considering the planar structure information of the prediction node in the prediction frame. In this way, coding efficiency of geometric information of a point cloud may be effectively improved by considering correlation between planar structure information of corresponding nodes in adjacent prediction frames. In addition, time domain correlation between the adjacent prediction frames is used to remove redundancy of planar structure information between the adjacent frames, which may further improve the coding efficiency of the geometric information of the point cloud, thereby improving encoding and decoding performance of the point cloud.

What is claimed is:

1. A decoding method, applied to a decoder, wherein the method comprises:
determining, based on a prediction node that is in a prediction frame and corresponds to a current node, planar structure information of a preset node of the current node, wherein the preset node comprises the prediction node;
determining, based on the planar structure information of the preset node, context indication information of the current node;
determining, based on the context indication information, target context information; and
decoding a bitstream based on the target context information, to determine planar position information of the current node.

2. The method according to claim 1, wherein the prediction frame is a decoded frame, and the prediction frame is adjacent to a current frame that comprises the current node.

3. The method according to claim 1, wherein the method further comprises:
determining occupancy information of the prediction node;
determining, based on the occupancy information of the prediction node, planar mode information of the prediction node; and
determining, based on the planar mode information of the prediction node, whether a plane coding mode is enabled for the current node in a preset direction.

4. The method according to claim 1, wherein the determining, based on the planar structure information of the preset node, the context indication information of the current node comprises:
determining, based on the planar structure information of the preset node, planar structure information of a first type preset node and planar structure information of a second type preset node; determining, based on the planar structure information of the first type preset node, first context indication information of the current node; and determining, based on the planar structure information of the second type preset node, second context indication information of the current node; or
determining, based on the planar structure information of the preset node, a first type planar structure information of the preset node and a second type planar structure information of the preset node; determining, based on the first type planar structure information of the preset node, first context indication information of the current node; and determining, based on the second type planar structure information of the preset node, second context indication information of the current node.

5. The method according to claim 4, wherein the determining, based on the context indication information, the target context information comprises:
acquiring the first context indication information of the current node and the second context indication information of the current node; and
determining, based on the first context indication information and the second context indication information, the target context information.

6. The method according to claim 5, wherein the determining, based on the first context indication information and the second context indication information, the target context information comprises:
performing context mapping processing according to the first context indication information and the second context indication information, to obtain new context information; and
determining, based on the new context information, the target context information.

7. The method according to claim 5, wherein the determining, based on the context indication information, the target context information comprises:
determining reference context information of the current node; and
determining, based on the first context indication information, the second context indication information, and the reference context information, the target context information.

8. The method according to claim 7, wherein the determining the reference context information of the current node comprises at least one of following:
performing prediction, based on occupancy information of the neighboring node, to determine a predicted value of the planar position information of the current node, wherein the predicted value comprises one of following: being a low plane, being a high plane, or being unpredictable;
determining a spatial distance between the current node and a node at a same partitioning depth and a same coordinate as the current node, wherein the spatial distance comprises one of following: a short distance or a long distance;
determining whether the node at the same partitioning depth and the same coordinate as the current node is a plane, and if the node is a plane, determining a planar position of the node; or
determining coordinate dimension information of the current node.

9. The method according to claim 1, wherein the method further comprises:
determining occupancy information of the prediction node;
determining, based on the occupancy information of the prediction node, planar structure information of the prediction node; and
determining, based on the planar structure information of the prediction node, whether a plane coding mode is enabled for the current node in a preset direction.

10. The method according to claim 9, wherein the determining, based on the planar structure information of the prediction node, whether the plane coding mode is enabled for the current node in the preset direction comprises:
acquiring reference information of the current node; and
determining, based on the planar structure information of the prediction node and the reference information of the current node, whether the plane coding mode is enabled for the current node in the preset direction.

11. An encoding method, applied to an encoder, wherein the method comprises:
determining, based on a prediction node that is in a prediction frame and corresponds to a current node, planar structure information of a preset node of the current node, wherein the preset node comprises the prediction node;
determining, based on the planar structure information of the preset node, context indication information of the current node;
determining, based on the context indication information, target context information; and
determining planar position information of the current node, encoding, based on the target context information, the planar position information of the current node, and writing an encoded bit into a bitstream.

12. The method according to claim 11, wherein the prediction frame is an encoded frame, and the prediction frame is adjacent to a current frame that comprises the current node.

13. The method according to claim 11, wherein the method further comprises:
determining occupancy information of the prediction node;
determining, based on the occupancy information of the prediction node, planar mode information of the prediction node; and
determining, based on the planar mode information of the prediction node, whether a plane coding mode is enabled for the current node in a preset direction.

14. The method according to claim 11, wherein the determining, based on the planar structure information of the preset node, the context indication information of the current node comprises:
determining, based on the planar structure information of the preset node, planar structure information of a first type preset node and planar structure information of a second type preset node; determining, based on the planar structure information of the first type preset node, first context indication information of the current node; and determining, based on the planar structure information of the second type preset node, second context indication information of the current node; or
determining, based on the planar structure information of the preset node, a first type planar structure information of the preset node and a second type planar structure information of the preset node; determining, based on the first type planar structure information of the preset node, first context indication information of the current node; and determining, based on the second type planar structure information of the preset node, second context indication information of the current node.

15. The method according to claim 14, wherein the determining, based on the context indication information, the target context information comprises:
acquiring the first context indication information of the current node and the second context indication information of the current node; and
determining, based on the first context indication information and the second context indication information, the target context information.

16. The method according to claim 15, wherein the determining, based on the first context indication information and the second context indication information, the target context information comprises:
performing context mapping processing according to the first context indication information and the second context indication information, to obtain new context information; and
determining, based on the new context information, the target context information.

17. The method according to claim 15, wherein the determining, based on the context indication information, the target context information comprises:
determining reference context information of the current node; and
determining, based on the first context indication information, the second context indication information, and the reference context information, the target context information.

18. The method according to claim 17, wherein the determining the reference context information of the current node comprises at least one of following:
performing prediction, based on occupancy information of the neighboring node, to determine a predicted value of the planar position information of the current node, wherein the predicted value comprises one of following: being a low plane, being a high plane, or being unpredictable;
determining a spatial distance between the current node and a node at a same partitioning depth and a same coordinate as the current node, wherein the spatial distance meets one of following: a short distance or a long distance;
determining whether the node at the same partitioning depth and the same coordinate as the current node is a plane, and if the node is a plane, determining a planar position of the node; or
determining coordinate dimension information of the current node.

19. The method according to claim 11, wherein the method further comprises:
determining occupancy information of the prediction node;
determining, based on the occupancy information of the prediction node, planar structure information of the prediction node; and
determining, based on the planar structure information of the prediction node, whether a plane coding mode is enabled for the current node in a preset direction;
wherein the determining, based on the planar structure information of the prediction node, whether the plane coding mode is enabled for the current node in the preset direction comprises:
acquiring reference information of the current node; and
determining, based on the planar structure information of the prediction node and the reference information of the current node, whether the plane coding mode is enabled for the current node in the preset direction.

20. A non-transitory storage medium, comprising a bitstream, wherein the bitstream is generated by:
determining, based on a prediction node that is in a prediction frame and corresponds to a current node, planar structure information of a preset node of the current node, wherein the preset node comprises the prediction node;
determining, based on the planar structure information of the preset node, context indication information of the current node;
determining, based on the context indication information, target context information; and
determining planar position information of the current node, encoding, based on the target context information, the planar position information of the current node, and writing an encoded bit into the bitstream.
